(19) United States
(12) Patent Application Publication
(10) Pub. No.: US 2025/0005341 A1
(43) Pub. Date: Jan. 2, 2025

(54) COMPUTING APPARATUS BASED ON SPIKING NEURAL NETWORK AND OPERATING METHOD OF COMPUTING APPARATUS

(71) Applicants: SAMSUNG ELECTRONICS CO., LTD., Suwon-si (KR); SEOUL NATIONAL UNIVERSITY R&DB FOUNDATION, Seoul (KR)

(72) Inventors: Sangbum KIM, Seoul (KR); Sung Min LEE, Yongin-si (KR); Hoonroe LEE, Seoul (KR); Hyunin MOON, Seoul (KR)

(73) Assignees: SAMSUNG ELECTRONICS CO., LTD., Suwon-si (KR); SEOUL NATIONAL UNIVERSITY R&DB FOUNDATION, Seoul (KR)

(21) Appl. No.: 18/654,940

(22) Filed: May 3, 2024

(30) Foreign Application Priority Data
Jun. 29, 2023 (KR) 10-2023-0084107
Oct. 24, 2023 (KR) 10-2023-0143294

(51) Int. Cl. G06N 3/049; G06N 3/084

(52) U.S. Cl. CPC G06N 3/049; G06N 3/084

(57) ABSTRACT

A computing device and an operating method of the computing device based on a spiking neural network (SNN) are disclosed. The computing device includes a pulse generator configured to generate a pulse corresponding to an input spike signal; an SNN including layers of spiking neurons each generating an output spike signal by applying the pulse to a neuron model; and a loss circuit module configured to calculate a loss value based on a potential value accumulated by the output spike signal generated for each of the layers and backpropagate the loss value to the SNN.

### CROSS-REFERENCE TO RELATED APPLICATIONS

This application claims priority to Korean Patent Application No. 10-2023-0084107 filed on Jun. 29, 2023, and Korean Patent Application No. 10-2023-0143294 filed on Oct. 24, 2023, in the Korean Intellectual Property Office, the disclosures of which are incorporated herein by reference in their entireties.

### BACKGROUND

### 1. Field

Methods and apparatuses consistent with embodiments relate to a computing device based on a spiking neural network (SNN) and an operating method of the computing device.

### 2. Description of the Related Art

A spiking neural network (SNN) is a type of neural network in which neurons of a neural network model communicate through sequences of spikes. In the SNN, a spike (e.g., a brief electrical pulse or signal serving a unit of information) may be emitted from a neuron when the neuron reaches a certain threshold, and then propagated through a network including neurons and synapses. The SNN may exchange discrete information indicating whether a spike occurs in a specific neuron at a specific time, unlike a deep learning network such as a multilayer perceptron (MLP), a recurrent neural network (RNN), and a convolutional neural network (CNN) that exchanges tensors or floats.

### SUMMARY

According to an aspect of various example embodiments, there is provided a computing device including: a pulse generator configured to generate a pulse corresponding to an input spike signal; a spiking neural network (SNN) comprising layers of spiking neurons configured to generate an output spike signal in response to the pulse being received from the pulse generator; and a loss circuit module configured to calculate a loss value based on a potential value accumulated by the output spike signal and backpropagate the loss value to the SNN.

The SNN may be configured to calculate the loss value for all time steps of forward propagation, and the loss circuit module may be configured to backpropagate a loss value of a last time step of the forward propagation of the loss value.

The SNN may include at least one of: a plurality of synaptic cells configured to store weight values in the form of a crossbar array (CBA); a neuron circuit that is based on a current-based leaky integrate-and-fire (LIF) neuron model in which an activity of a pre-synaptic neuron among the spiking neurons is reflected; or a loss-2-pulse circuit configured to receive the loss value calculated by the loss circuit module, generate a pulse corresponding to the loss value, and transmit the pulse to the neuron circuit.

The loss circuit module may be configured to normalize the accumulated potential value and backpropagate, to the SNN, the loss value that is based on a difference between the normalized potential value and a label vector.

The loss circuit module may include: a spike counter circuit configured to accumulate the potential value by the output spike signal; a normalization circuit configured to normalize the accumulated potential value; and a loss circuit configured to calculate the loss value based on the difference between the normalized potential value and the label vector.

The computing device may be configured to, during the backpropagation, replace an activation function of the spiking neurons with an extended boxcar function in which a window controlling a membrane potential range through which gradients pass is extended.

The computing device may be configured to backpropagate, to all the spiking neurons, a loss value of a last layer of the SNN, regardless of whether the spiking neurons fire during the forward propagation of the loss value.

The computing device may be configured to, during the backpropagation of the loss value, propagate the loss value to all elements of a kernel at the same time.

The computing device may further include: an eligible potential generation circuit configured to receive the pulse, calculate an eligible potential value corresponding to the pulse, and transmit the calculated eligible potential value as the output spike signal to the SNN.

The eligible potential generation circuit may be configured to calculate the eligible potential value by applying a clamp function to a result of adding a membrane potential value of a spike of a previous time step and a scaled spike value of a current time step.

The eligible potential generation circuit may be configured to calculate an eligible spike by applying a Heaviside function to a difference between the eligible potential value and a threshold value of the eligible spike.

The the SNN is further configured to compute a weighted sum of the output spike signal that is output from the eligible potential generation circuit using a weight stored in a synaptic cell of the SNN, and store the weighted sum in a neuron circuit of the SNN.

The eligible potential generation circuit may include at least one of: an eligible potential circuit configured to calculate the eligible potential value according to time corresponding to the pulse to be in a leaky-integration (LI) form by a resistor-capacitor (RC) circuit; a threshold comparator configured to compare the eligible potential value to a threshold value of an eligible spike; or a flag generator configured to store a flag value corresponding to the eligible spike based on a comparison between the eligible spike and the threshold value.

The SNN may include a CBA, and the flag value may be applied as a pulse that selects a synaptic cell from rows of the CBA.

The threshold comparator may include: an operational amplifier (OP-AMP) circuit or a bi-stable circuit with a series of NOT gates.

The loss circuit module may be configured to: in response to a backpropagation (BP) signal being input, calculate the loss value and backpropagate the loss value to the SNN; and in response to a reset signal, reset the accumulated potential value stored in a spike counter circuit of the loss circuit module.

According to another aspect of various example embodiments, there is provided a training method of a computing device to train an SNN. The SNN may include a plurality of layers each including a pre-synaptic neuron, a membrane potential, a post-synaptic neuron, and an accumulative neuron. The training method may include: by each of the layers, calculating a loss value through forward propagation for all time steps based on the membrane potential and a potential value accumulated in the accumulative neuron in response to an output spike signal generated from a spiking neuron, the spiking neuron including the pre-synaptic neuron and the post-synaptic neuron; and training the SNN by backpropagating a loss value of a last time step of the forward propagation of the loss value.

The calculating of the loss value through the forward propagation may include: for each of all the time steps, receiving an output spike signal that is output from the pre-synaptic neuron of a previous layer; transmitting, to the membrane potential, a value obtained by a weighted sum of the potential value accumulated by the output spike signal and a weight corresponding to a current layer; outputting a loss value corresponding to the current layer based on a difference between the potential value transmitted to the membrane potential and a membrane potential threshold value; calculating an eligible spike value by scaling the output spike signal based on a clamp function and performing binarization; and storing, in a memory, the eligible spike value as an eligible potential value for each of the time steps.

The training of the SNN may include: comparing the eligible potential value stored in the memory to a threshold value of an eligible spike; and in response to the eligible potential value being greater than or equal to the threshold value of the eligible spike, generating the eligible spike and updating a weight for the SNN to train the SNN.

### BRIEF DESCRIPTION OF THE DRAWINGS

The above and/or other aspects will be more apparent by describing certain example embodiments, taken in conjunction with the accompanying drawings, in which:

FIG. 1 is a diagram illustrating a hardware implementation of a spiking neural network (SNN) according to an example embodiment;

FIGS. 2A and 2B are diagrams illustrating an operating method of an SNN according to an example embodiment;

FIG. 3 is a roll-up diagram illustrating a surrogate online learning at once (hereinafter “SOLO”) algorithm used to train an SNN according to an example embodiment;

FIG. 4 is a graph illustrating an extended boxcar function used as a kernel function in an SNN according to an example embodiment;

FIG. 5 is a diagram illustrating an operation of a spike counter of an SNN according to an example embodiment;

FIG. 6 is a diagram illustrating an always-on pooling operation according to an example embodiment;

FIG. 7 is a diagram illustrating an operation of an eligible potential generation circuit according to an example embodiment;

FIG. 8 is a diagram illustrating an eligible trace by an eligible potential generation circuit according to an example embodiment;

FIG. 9 is a diagram illustrating an example of a crossbar array (CBA) circuit in which an eligible potential generation circuit is implemented according to an example embodiment;

FIG. 10 is a block diagram illustrating an eligible potential generation circuit according to an example embodiment;

FIG. 11 is a diagram illustrating an example of a threshold comparator for an eligible spike according to an example embodiment;

FIG. 12 is a diagram illustrating a structure and operations of a loss circuit module of an SNN according to an example embodiment;

FIG. 13 is a diagram illustrating a method of performing backpropagation in a specific time step of a SOLO used to train an SNN according to an example embodiment;

FIG. 14 is a diagram illustrating a method of performing backpropagation in a specific time step of a SOLO by receiving a signal from a specific module of an SNN according to an example embodiment;

FIG. 15 is a diagram illustrating an example of a CBA system in which an SNN is implemented according to an example embodiment; and

FIG. 16 is a flowchart illustrating a training method performed by a computing device to train an SNN according to an example embodiment.

### DETAILED DESCRIPTION

The following structural or functional descriptions of example embodiments are provided to merely describe the example embodiments, and the scope of the example embodiments is not limited to the descriptions provided in the disclosure. Various changes and modifications can be made thereto by those of ordinary skill in the art.

Although terms of “first” or “second” are used to explain various components, the components are not limited to the terms. These terms should be used only to distinguish one component from another component. For example, a “first” component may be referred to as a “second” component, or similarly, and the “second” component may be referred to as the “first” component within the scope of the right according to the concept of the present disclosure.

It will be understood that when a component is referred to as being “connected to” another component, the component can be directly connected or coupled to the other component or intervening components may be present.

As used herein, the singular forms are intended to include the plural forms as well, unless the context clearly indicates otherwise. It should be further understood that the terms “comprises,” “comprising,” “includes,” and/or “including,” when used in this specification, specify the presence of stated features, integers, steps, operations, elements, components or a combination thereof, but do not preclude the presence or addition of one or more other features, integers, steps, operations, elements, components, and/or groups thereof.

Unless otherwise defined herein, all terms used herein including technical or scientific terms have the same meanings as those generally understood by one of ordinary skill in the art. Terms defined in dictionaries generally used should be construed to have meanings matching with contextual meanings in the related art and are not to be construed as an ideal or excessively formal meaning unless otherwise defined herein.

Hereinafter, example embodiments will be described in detail with reference to the accompanying drawings. When describing the example embodiments with reference to the accompanying drawings, like reference numerals refer to like components and a repeated description related thereto is omitted.

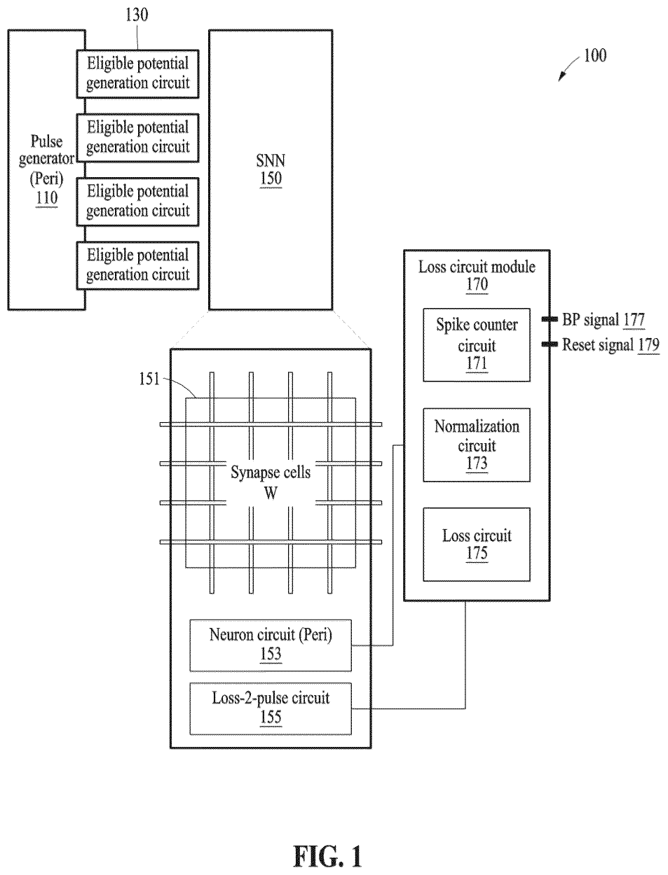

FIG. 1 is a diagram illustrating a hardware implementation of a spiking neural network (SNN) according to an example embodiment. Referring to FIG. 1, according to an example embodiment, a computing device 100 may include a pulse generator 110, eligible potential generation circuits 130, an SNN 150, and a loss circuit module 170. The computing device 100 may be also refer to as a machine learning accelerator, a neural network accelerator, or a neuromorphic processor.

The pulse generator 110 may generate a pulse corresponding to an input spike signal. The pulse generator 110 may provide the generated pulse to the eligible potential generation circuits 130 and the SNN 150.

The eligible potential generation circuits 130 may receive the pulse from the pulse generator 110, calculate an eligible potential value corresponding to the pulse, and transmit an output spike signal including the calculated eligible potential value to the SNN 150.

The eligible potential generation circuits 130 may represent an activity of a pre-synaptic neuron of the SNN 150 and may apply an eligible trace to a weight update rule. The eligible potential generation circuits 130 may be replaced, and applied as, with gradient operation elements of a chain rule on a crossbar array (CBA) in the form of a binary local temporal memory. The number of eligible potential generation circuits 130 may correspond to the number of rows of synaptic cells 151 of the SNN 150 through a one-to-one correspondence.

As will be described in more detail below with reference to Equation 6, the eligible potential generation circuits 130 may calculate the eligible potential value by applying a clamp function to a result of adding a membrane potential value of a spike of a previous time step and a scaled spike value of a current time step. The eligible potential generation circuits 130 may also calculate an eligible spike by applying a Heaviside function to a difference between the eligible potential value and a threshold value of the eligible spike.

Output spikes generated from the eligible potential generation circuits 130 may be added through a multiplication operation with weights stored in the synaptic cells 151 of the SNN 150. A result of the adding may be stored in a neuron circuit 153 of the SNN 150.

During forward propagation, an input of the CBA of the SNN 150 and an input of the eligible potential generation circuits 130 may be calculated (or computed) in parallel and may be distinguished from each other. At the same time, each of the eligible potential generation circuits 130 may receive a pulse corresponding to a spike from the pulse generator 110.

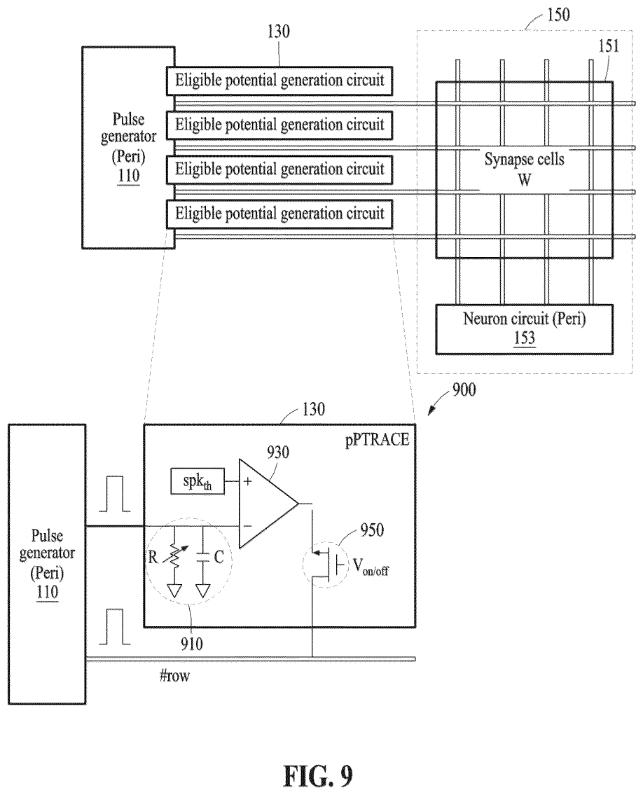

In addition, during the forward propagation, each of the eligible potential generation circuits 130 may calculate an eligible potential value. The eligible potential generation circuits 130 may each be configured as, for example, a resistor-capacitor (RC) circuit including a resistor R and a capacitor C that are connected in parallel. In the RC circuit, the resistor R may be implemented as a variable resistor, and a resistance (or variable resistance) may be learned according to a gradient of the chain rule. In this case, the “chain rule” may correspond to a formula that expresses the constituent derivatives of two differentiable functions f and g as derivatives of f and g. The eligible potential generation circuits 130 may each correspond to, for example, a pseudo-parametric spike trace (hereinafter referred to as “pPTRACE”), which will be described below with reference to FIG. 9. The structure and operations of the eligible potential generation circuits 130 will be described in more detail below with reference to FIG. 9.

The SNN 150 may include layers of spiking neurons that generate output spike signals by applying the pulse generated by the pulse generator 110 to a neuron model. The “spiking neuron(s)” may constitute the SNN 150, and a spiking neuron may refer to a neuron that fires a spike when a potential of the neuron exceeds a membrane potential threshold value. The spiking neuron may generate an electrical pulse that is referred to as an action potential or spike. The spiking neuron may process information from multiple inputs to generate a single output spike signal.

The SNN 150 may perform energy-efficient calculations (or computation) and replicate cognitive functions similar to those performed by the human brain. In the SNN 150, spiking neurons may transmit information using binary or sparse spikes, enabling an intuitive hardware design and event-based computing. However, in the existing art, there may be a lack of efficient training methods for deep SNNs (e.g., the SNN 150) that have online learning rules that mimic biological systems for distribution to a neuromorphic computing substrate.

In an example embodiment, a surrogate online learning at once (hereinafter, referred to as “SOLO”) algorithm may be performed for the SNN 150 using some surrogate strategies that may be implemented in a hardware-friendly manner.

As will be described in more detail below, backpropagation, which is a learning method of an artificial neural network (ANN), may be applied to train the SNN 150. For example, a gradient-based direct learning method using a surrogate gradient (SG) may be used to train the SNN 150 of high performance with large datasets with an extremely short latency. However, in the SNN 150, there may be a difficulty due to memory requirements expanding according to the number of time steps that increases during learning (or training) due to a credit assignment problem that may arise from representing each rapidly growing neuron as its own recurrent neural network (RNN). Moreover, the gradient-based direct learning method using an SG may deviate from the principles of biological online learning, which serves as the learning rule in the neuromorphic substrate, and may thus be inefficient in actual tasks in terms of memory and time complexity despite its compatibility with event-based inputs and various spiking neuron models.

The computing device 100 may have an embedded neuromorphic substrate that may be implemented in consideration of an influence on a neuromorphic computing (NC) chip to achieve expandable online on-chip learning for the SNN 150. The computing device 100 may use an online on-chip learning algorithm that is designed jointly with the neuromorphic substrate to reproduce complex biological functions with leakage characteristics at low power consumption, and may thereby implement the SNN 150 of high performance with low latency and maintain online learning characteristics.

In an example embodiment, the SOLO algorithm for the SNN 150, which uses four surrogate strategies, may be used to perform learning with low computational complexity using a gradient of ae final time step. The SOLO algorithm may be designed to be hardware-friendly and may perform efficient on-chip learning using local information. The SOLO algorithm may address non-idealities in an analog computing substrate including device mismatch and thermal noise and an issue of device endurance associated with a lack of write access.

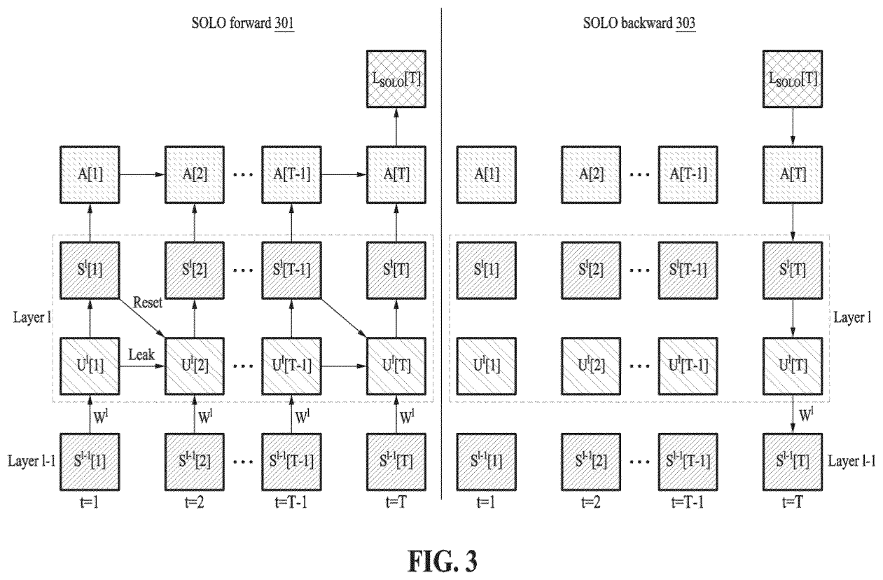

As will be described in more detail below with reference to FIG. 3, the computing device 100 may backpropagate spatial information (e.g., a special gradient or a spatial loss) of a last time step without reflecting a temporal loss and a spatial-temporal loss of the SNN 150. Therefore, the computing device 100 may have a small memory and time complexity and may reflect a gradient for a weight in real time. In this case, the computing device 100 may reflect temporal information to the maximum through a local memory of the SNN 150. The computing device 100 may replace the temporal information and reflect spatial information in the SNN 150, based on a spatial weight update rule of a surrogate gradient learning (SGL) method. In this case, the SGL method may enable backpropagation learning by using surrogate gradients in a non-differentiable activation function of neurons in a known SNN system, and may replace a non-differentiable part with a surrogate gradient value during the learning process.

In the SGL method, all gradients may be divided into a temporal gradient, a spatial gradient, and a spatial-temporal gradient. The temporal gradient may occur along a time axis between a current membrane potential and a previous membrane potential. The temporal gradient may pertain to the change or variation in parameters of the SNN 150 over time, and may involve adjustments made to parameters based on the progression of time during the learning process. The spatial gradient pertains to the change or variation in the network parameters concerning spatial dimensions, and may involve the adjustment of the network parameters based on the spatial arrangement of neurons within the SNN 150. The spatial-temporal gradient may occur along the time axis between a current membrane potential and a previous spike occurrence. The spatial-temporal gradient may correspond to, for example, a gradient that flows horizontally and diagonally in a roll-up diagram of FIG. 3. Unlike the temporal gradient and the spatial-temporal gradient, the spatial gradient may occur by a spatial relationship independently of the time axis. The spatial gradient may correspond to a gradient that flows vertically in the roll-up diagram.

In the SGL method, weights may always be present between a previous layer and a current layer of the SNN 150. Instead of having distinct or separate spatial weights, the above-described three types of gradients may be applied, and the weights may be updated based on a gradient selected from among the three types of gradients. The eligible trace described above may correspond to a method of replacing a temporal gradient with a type of spatial gradient.

The SOLO algorithm may correspond to a learning method that replaces temporal information with spatial information.

The computing device 100 may include, as hardware components, four surrogate strategies to be described in detail below. The four surrogate strategies used in the SOLO algorithm for the SNN 150 will be described in more detail below with reference to FIGS. 3 to 11.

The SNN 150 may include, for example, the synaptic cells 151, the neuron circuit 153, and a loss-2-pulse circuit 155.

The synaptic cells 151 may be in the form of a CBA that may store a weight value for each synaptic cell.

The neuron circuit 153 may be based on a current-based leaky integrate-and-fire (LIF) neuron model that reflects therein an activity of a pre-synaptic neuron among the spiking neurons. The neuron circuit 153 may include a pseudo-parametric LIF (pPLIF) spiking neuron model and learnable time constant parameters that are referred to as pseudo-parametric leaky integration (pPLI) neurons, which will be described below.

The loss-2-pulse circuit 155 may receive the loss value calculated by the loss circuit module 170, generate a pulse corresponding to the loss value, and transmit the pulse to the neuron circuit 153.

The loss circuit module 170 may calculate a loss value based on an accumulated potential value by an output spike signal generated for each layer of the SNN 150 and may backpropagate the loss value to the SNN 150.

The SNN 150 may calculate a loss value for all the time steps during forward propagation. A time step may refer to a specific iteration in the unfolding of the recurrent connections of the SNN 150 over a sequence of input data. In the forward pass at each time step, the SNN 150 may process input data and compute activations at a specific layer of the SNN 150. For example, in the case where the SNN 150 includes n layers, the processing of input data and the computation of activations may take place over n time steps, with each layer processed at each respective time step. The loss circuit module 170 may backpropagate a loss value of a last time step of the forward propagation of the loss value.

The loss circuit module 170 may normalize a potential value accumulated in a spike counter circuit 171. The loss circuit module 170 may backpropagate to the SNN 150, a loss value that is calculated based on a difference between the normalized potential value and a label vector.

The loss circuit module 170 may include, for example, the spike counter circuit 171, a normalization circuit 173, and a loss circuit 175. To the loss circuit module 170, a backpropagation signal 177 (or “BP signal”) and a reset signal 179 (or “Reset signal”) may be applied.

The spike counter circuit 171 may accumulate potential values by the output spike signal. The spike counter circuit 171 may correspond to accumulative neurons to be described below.

The loss circuit module 170 may transmit the accumulated potential value to the spike counter circuit 171 for all the time steps to the normalization circuit 173.

The normalization circuit 173 may normalize a potential transmitted from the spike counter circuit 171 by applying an activation function such as, for example, a softmax function or a scaling function. That is, the normalization circuit 173 may output a probability of a class corresponding to the potential transmitted from the spike counter circuit 171.

The loss circuit 175 may calculate the loss value based on the difference between the potential value normalized by the normalization circuit 173 and the previously stored label vector. The loss circuit 175 may calculate the loss value corresponding to the probability of the class output from the normalization circuit 173. The loss value generated in the loss circuit module 170 may be transmitted back to the loss-2-pulse circuit 155 of the SNN 150. The loss-2-pulse circuit 155 may generate a pulse corresponding to the transmitted loss and transmit the pulse to the neuron circuit 153. The neuron circuit 153 may apply a learning rate value to the loss value and apply it to the weight update rule.

The loss circuit module 170 may not operate for all time steps but may operate in a specific time step by receiving a specific signal.

The BP signal 177 may correspond to a signal that allows the loss circuit module 170 to be driven to derive a loss value and perform backpropagation.

The reset signal 179 may correspond to a signal that resets the accumulated potential values stored in the accumulative neurons, i.e., the spike counter circuit 171.

After the loss circuit module 170 is operated according to the BP signal 177, the reset signal 179 may be transmitted, but examples are not necessarily limited thereto. The BP signal 177 and the reset signal 179 may operate independently of each other. The BP signal 177 and the reset signal 179 may operate mainly on static data.

In an example embodiment, the SOLO algorithm may be implemented based on a LIF neuron model that is converted into an iterative expression using the Euler method. In this case, a parametric LIF (PLIF) neuron may be used to improve SNN performance by introducing a learnable membrane potential time constant τ.

In addition, in an example embodiment, a pPLIF spiking neuron model may be used to learn a membrane potential time constant of the SNN 150. Compared to a PLIF neuron model, the pPLIF spiking neuron model may facilitate further hardware porting and may simplify the calculation of gradients flowing to the learnable membrane potential time constant τ. The membrane potential time constant t may be shared within spiking neurons in the same layer of the SNN 150.

In an example embodiment, a simple current model corresponding to the pPLIF spiking neuron model may be expressed as Equation 1 below.

$${I}_{i}^{l} [ t ] = {ΣW}_{ij}^{l} {S}_{j}^{l - 1} [ t ] \qquad [ Equation 1 ]$$

In Equation 1, a subscript “i” denotes an i-th neuron, Wᵢⱼ^{l} denotes a weight without a bias from a neuron j to a neuron i in a layer l. Sⱼ^{l-1} indicates whether an output spike occurs (or exists) at a neuron j of a layer l−1. In the presence of the output spike at the neuron j of the layer l−1, Sⱼ^{l-1} is 1 (i.e., Sⱼ^{l-1}=1), but in the absence of the output spike, Sⱼ^{l-1} is zero (i.e., Sⱼ^{l-1}=0).

In this case, a discrete computational form of the current model of Equation 1 may be expressed as Equation 2 below.

$$\{ \begin{matrix}{U}_{i}^{l} [ t ] = {β}^{l} {U}_{i}^{l} [ t - 1 ] ( 1 - {S}_{i}^{l} [ t - 1 ] ) + {I}_{i}^{l} [ t ] \\ {S}_{i}^{l} [ t ] = Θ ( {U}_{i}^{l} [ t ] - {ϑ}_{th} )\end{matrix} \qquad [ Equation 2 ]$$

In Equation 2, Uᵢ^{l} denotes a subthreshold membrane potential of the neuron i in the layer l of the SNN 150. A threshold used herein may correspond to a membrane potential threshold value. β^{l}=1/(1+exp(−τₘₑₘ^{l})) denotes a membrane potential decaying constant of the layer l. τₘₑₘ^{l} denotes a membrane potential time constant of the layer l. Sᵢ^{l} denotes an occurrence of an output spike of the neuron i in the layer l. Θ(·) denotes a Heaviside function. The Heaviside function may also be referred to as a “unit step function,” and may output zero (0) for real numbers less than 0, output 1 for real numbers greater than 0, and output 0.5 for 0. ϑₜₕ denotes a membrane potential threshold value. A reset operation may be implemented by multiplying the occurrence of the output spike of the neuron i in a time step t−1.

Before calculating a loss using a spike counting method, the computing device 100 may update the output spikes counted by the spike counter circuit 171 into a spike accumulator. The spike accumulator may correspond to a module that performs an accumulation operation on an output spike signal of the SNN 150. An accumulated value of the spike accumulator may be applied to a mean squared error (MSE) loss operator after the last layer of the SNN 150. The spike accumulator may be positioned before the MSE loss operator.

The SNN 150 may include accumulative neurons that may operate in both an integrate mode (or I mode) that is the same as the spike accumulator, and a pseudo-parametric leaky integration (pPLI) neuron model using a learnable membrane potential time constant. The accumulative neurons may count spikes through an operation of the pPLI neuron model.

The operation of the accumulative neurons may be similar to that of the pPLI neuron model, and the pPLI neuron model may be similar to the pPLIF neuron model without firing.

The operation of the accumulative neurons may be expressed as Equation 3 below.

$${A}_{i} [ t ] = {β}^{A} {A}_{i} [ t - 1 ] + {S}_{i}^{L} [ t ] \qquad [ Equation 3 ]$$

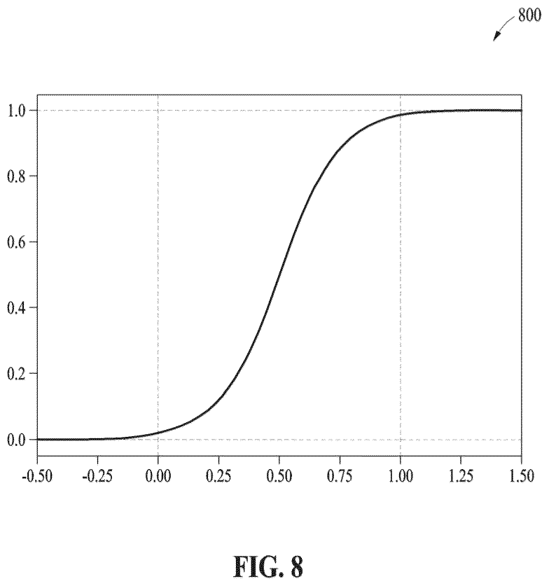

In Equation 3, Aᵢ denotes a membrane potential of an accumulative neuron i. β^{A}=exp(−1/τₘₑₘ^{A}) denotes a membrane potential decaying constant of the accumulative neuron i, in which β^{A} denotes a leaky property of a membrane. β^{A} may also correspond to sigmoid used as a clamp function to be described below with reference to FIG. 8. Sᵢ^{L} denotes an occurrence of an output spike of the neuron i in a last layer L of the SNN 150, in which L denotes the number of layers.

The computing device 100 may use extended spatial gradients in the last time step of forward propagation, corresponding to the last layer L of the SNN 150, such that the SOLO algorithm achieves low computational complexity while maintaining a similar convergence rate.

In addition, the SOLO algorithm update rule may be in the form of three-step Hebbian learning that enables online on-chip learning. In addition, the SOLO algorithm is hardware-friendly and may thus provide robustness against sparse write access to a memory device and against device non-idealities.

The SOLO algorithm may operate on other spiking circuits in addition to the computing device 100 according to an example embodiment.

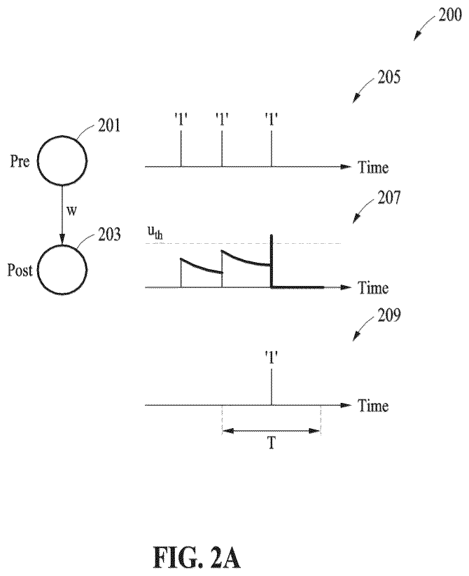

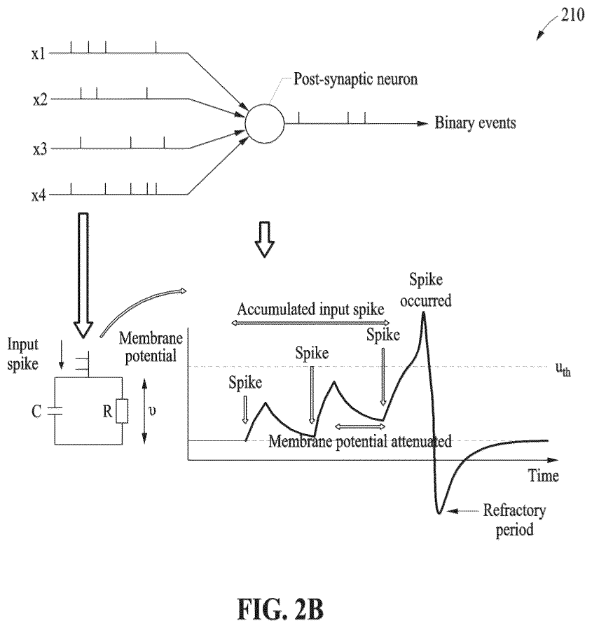

Hereinafter, before the SOLO algorithm for the SNN 150 using the four surrogate strategies, an information processing method of the SNN 150 will be described first with reference to FIGS. 2A and 2B.

FIGS. 2A and 2B are diagrams illustrating an operating method of an SNN according to an example embodiment. Referring to FIG. 2A, diagram 200 shows an information processing method performed in a case in which two spiking neurons, for example, a pre-synaptic neuron 201 and a post-synaptic neuron 203, are connected. In FIG. 2A, the symbol “T” denotes a single time step among all time steps.

When the pre-synaptic neuron 201 and the post-synaptic neuron 203 are connected as shown in FIG. 2A, the pre-synaptic neuron 201 may transmit information to the post-synaptic neuron 203. In this case, graph 205 may represent three spike signals sequentially transmitted from the pre-synaptic neuron 201 to the post-synaptic neuron 203 along a time axis. In addition, graph 207 may represent an action potential of the post-synaptic neuron 203 over time. It may be verified from the graph 207 that the action potential of the post-synaptic neuron 203 soars by a specific value each time it receives spike signals (e.g., a first spike signal and a second spike signal) from the pre-synaptic neuron 201 and is gradually attenuated by leakage over time. In this case, when the third spike signal is transmitted to the post-synaptic neuron 203 and the action potential exceeds a threshold uₜₕ shown in the graph 207, an output spike signal “1” may occur in the post-synaptic neuron 203 as shown in graph 209. Simultaneously with the occurrence of the output spike signal, a value of the action potential of the post-synaptic neuron 203 may be initialized to “0” as shown in the graph 207. The operation described in the foregoing may be similarly applied even when multiple neurons are connected.

Referring to FIG. 2B, diagram 210 shows an operation of a LIF neuron model.

An SNN may involve a concept of time in an interaction between neuron(s) and neurons called spikes. In the SNN, an internal state of a neuron may be changed by temporal information and a spike signal transmitted from another neuron, and a spike may occur when the changed internal state of the neuron satisfies a specific condition.

A neural cell body of a neuron may have inner and outer sides separated by a cell membrane, forming a membrane potential. The cell membrane may be modeled as a LIF neuron model shown in FIG. 2B.

The LIF neuron model may model the following rules of a neuron.
i) The LIF neuron model may put together spikes of pre-synaptic neurons. In this case, the spikes of the pre-synaptic neurons may be considered power coming from the outside and may correspond to a power source of the neuron.
ii) The LIF neuron model may generate a spike when a membrane potential exceeds a threshold voltage and may be initialized with a reset voltage. The neuron may store sodium ions in the neuron through an action potential transmitted to a pre-synaptic neuron. Such a characteristic may be modeled as a capacitor C that temporarily stores power. In addition, the membrane potential may have a voltage that is increased by the action potential and returns to the reset voltage over time as ions escape through the (cell) membrane. Such an operation may be modeled as a resistor R. Based on the foregoing, the LIF neuron model may be implemented as an RC circuit. The cell membrane may be represented as the capacitor C of the RC circuit, and a potential difference between both ends of a storage battery may be expressed as the membrane potential. When an external current I is input to the RC circuit, the capacitor C corresponding to the storage battery may be charged.

Referring to FIG. 2B, when the post-synaptic neuron receives input spike signals x1, x2, x3, and x4 from a pre-synaptic neuron, and as the input spike signals x1, x2, x3, and x4 are accumulated in the post-synaptic neuron, the action potential (or the membrane potential) of the post-synaptic neuron exceeds the threshold uₜₕ, and the post-synaptic neuron may fire the action potential as an output spike. The membrane potential may accumulate with the presence of the input spike signals x1, x2, x3, and x4. Once the membrane potential exceeds the threshold uₜₕ, the neuron fires an action potential, and the membrane potential goes back to the reset voltage. The post-synaptic neuron may return back to the reset voltage after a refractory period has passed since the generation of the output spike. The “refractory period” may correspond to a period in which an initialized state immediately after spike generation is briefly maintained.
iii) In the LIF neuron model, a membrane potential voltage may continuously leak.

FIG. 3 is a roll-up diagram illustrating a SOLO algorithm used to train an SNN according to an example embodiment.

Referring to FIG. 3, a roll-up diagram 301 shows operations of forward propagation performed in an SNN, and roll-up diagram 303 shows operations of backpropagation performed in the SNN.

A backpropagation through time (hereinafter, “BPTT”) method may be applied in a backpropagation path of training an SNN, and may reflect a spatial loss, a temporal loss, and a spatial-temporal loss according to a chain rule. When a weight update rule is decomposed by the chain rule, it may be divided into the temporal loss, the spatial loss, and the spatial-temporal loss. The temporal loss may be propagated backward according to the chain rule in each time step, and as the number of time steps increases, a gradient for each weight may be accumulated.

According to an example embodiment, a computing device may perform backpropagation on spatial information of a last time step without reflecting the temporal loss and the spatial-temporal loss of the BPTT method. The computing device may reflect gradients for weights in real time while reducing memory usage and time complexity by reflecting temporal information to the maximum through a local memory on a network, thereby being suitable for on-chip learning and/or online learning.

The computing device may replace and reflect the temporal information, mainly focusing on a spatial weight update rule of an SGL method. The spatial weight update rule may be based on, for example, a loss, an activity of a pre-synaptic neuron, and an activity of a post-synaptic neuron. In the SGL method, to represent the activity of the pre-synaptic neuron as hardware, a current-based LIF neuron model may be used.

According to the roll-up diagram 301, the SNN may calculate a loss for all time steps (t=1, 2, . . . . T−1, and T) during forward propagation and perform backpropagation on a spatial loss in a last time step (t=T) among given time steps. The computing device may use four surrogate strategies to extend a gradient in the last time step of the SNN, which will be described in detail below. Hereinafter, the term “surro-” may be added to refer to surrogate strategies used in the SNN according to an example embodiment.

Referring to the roll-up diagram 303, a SOLO algorithm may follow a forward path through time steps and consider a backward path only for a last step. The SOLO algorithm may update the SNN by the spatial gradient in the last time step to reduce memory complexity and time complexity, thereby being effective in online learning.

In the backward path, the SOLO algorithm may propagate gradients to all elements of the SNN, ignoring a spatial gradient between accumulative neurons and an occurrence of a spike of a last layer of the SNN. In this case, the spatial gradient may refer to a gradient in a direction from top to bottom in the roll-up diagram 303, i.e., in a direction from L_{SOLO}[T] to S^{l-1}[T]. The temporal gradient may refer to a gradient in a direction from right to left, i.e., in a direction from U^{l}[T] to U^{l}[1]. In addition, the spatial-temporal gradient may refer to a gradient in a direction from bottom to top in the roll-up diagram 301, i.e., in a direction from S^{l-1}[T] to L_{SOLO}[T].

In this case, a gradient chain of the SOLO algorithm may be dependent on spatial gradients in a final step, and thus may not require backpropagation along temporal dimensions and spatial-temporal dimensions. Such an operation may indicate that a neuromodulator, which may be interpreted as an error signal of the SNN, is not secreted continuously but released spatially on a specific period.

The four surrogate strategies may train the SNN only using a spatial gradient in a last time step and may complement or extend gradient components (e.g., a temporal gradient and a spatial-temporal gradient) that are ignored during a learning process, thereby improving the accuracy of the SNN that is degraded by the ignored gradient components. Surrogate strategy 1 (simply “Surro 1”) to surrogate strategy 3 (simply “Surro 3”) may always be applied to train the SNN, but surrogate strategy 4 (simply “Surro 4”) may be applied selectively.

The four surrogate strategies may be simplified as follows.

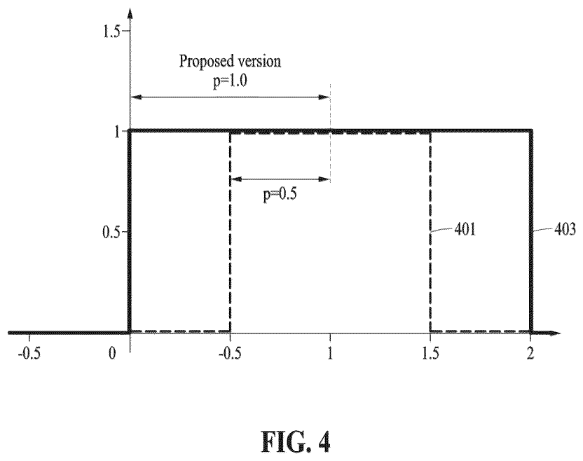

1) Surro 1 is to use an extended boxcar function for an activity of a post-synaptic neuron. A membrane potential has temporal information (e.g., temporal loss) due to the reflection of the LIF neuron model, and a value obtained as the temporal information passes through a surrogate kernel is reflected in the weight update rule. Surro 1 will be described in more detail below with reference to FIG. 4.

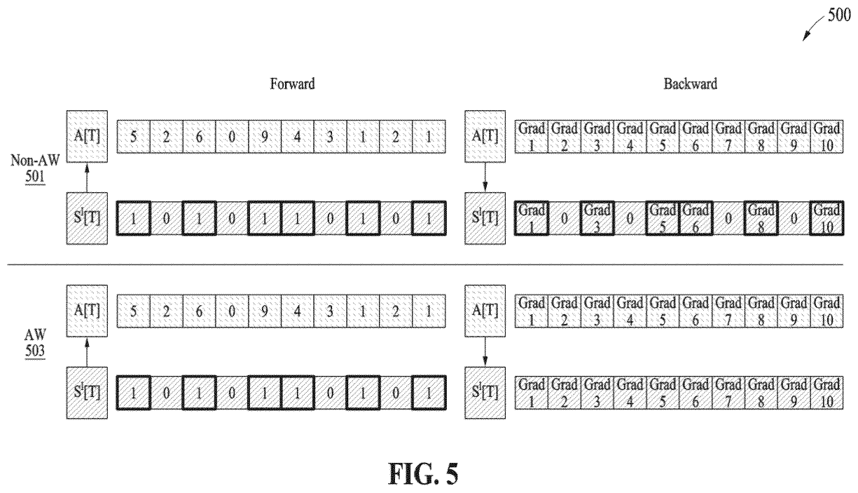

2) Surro 2 is to use an always-on strategy of a spike counter. According to Surro 2, the computing device may ignore a spatial gradient between the spike counter (e.g., the spike counter circuit 171 of FIG. 1) and an occurrence of an output spike of the SNN but may fix the spatial gradient always as “1” to extend a gradient in the last time step of the SNN. The computing device may extend and apply the spatial gradient between an accumulative neuron and the occurrence of the output spike of the SNN through Surro 2. Surro 2 will be described in more detail below with reference to FIG. 5.

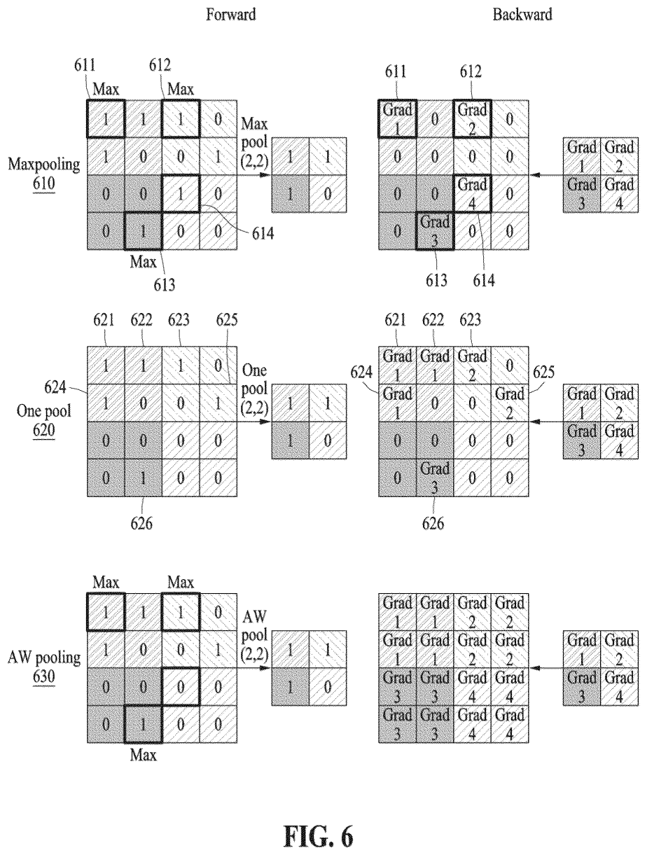

3) Surro 3 is to perform always-on pooling or one pooling. The term “pooling” used herein may refer to performing a pooling operation to reduce the size of a feature map by downsampling the feature map of the SNN, which may be performed by a pooling layer. The computing device may perform a max pooling operation to select a largest value from a pooling area (e.g., window) during forward propagation, but may extend and apply a gradient through the pooling during backpropagation to extend the gradient in the last time step of the SNN. Surro 3 will be described in more detail below with reference to FIG. 6.

4) Surro 4 is to use an eligible potential generation circuit (e.g., the eligible potential generation circuits 130 of FIG. 1). The computing device may represent an activity of a pre-synaptic neuron as a computation of an eligible potential and an eligible spike. In this case, the term “eligible trace” may refer to replacing previously visited states (e.g., previous neurons) with information that may currently refer to, determining a state that affects a specific cost function, and distributing it to the state. In this case, the specific cost function may include an error and a reward to be currently obtained. That is, in a case in which a current time step is t and the time step becomes t+n, a membrane potential value accumulated up to a point at which the time step becomes t+n may be calculated as an output spike value in n time steps, and a weight function of visited neurons in the n time steps may be updated. The eligible trace, which may reflect temporal data about an input spike signal applied to the SNN, may be reflected in the weight update rule. For the eligible trace, a binary spike may be used.

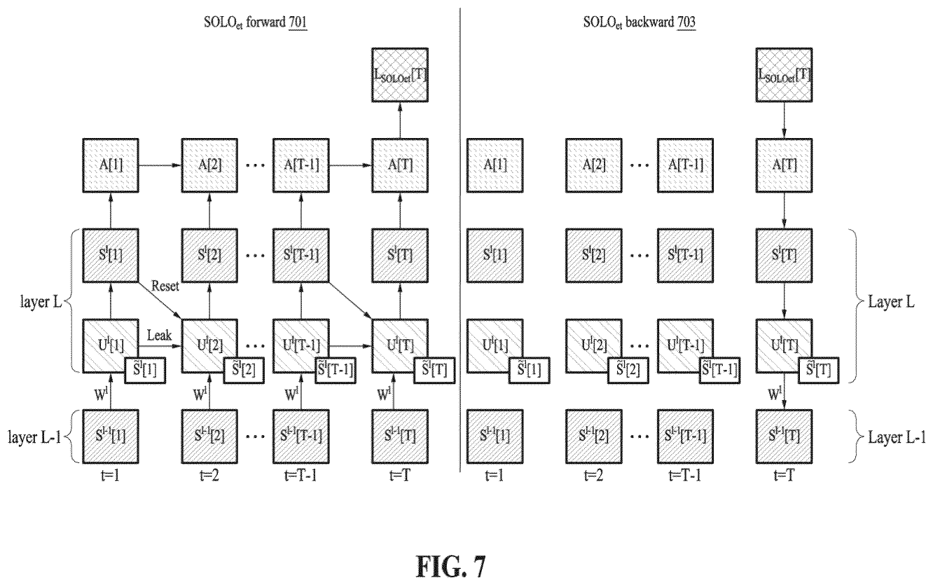

Through the eligible trace, the computing device may change and express a gradient over time to spatial information or a trace value that may refer to at the corresponding time, and thus may not calculate a temporal gradient chain. This may indicate that a computational amount along the time axis does not increase as a time step increases, that is, time complexity is independent of the time step. Surro 4 will be described in more detail below with reference to FIGS. 7 to 11.

FIG. 4 is a graph illustrating an extended boxcar function used as a kernel function in an SNN according to an example embodiment.

Referring to FIG. 4, graph 401 shows a general boxcar function, and graph 403 shows an extended boxcar function according to Surro 1 according to an example embodiment. In the graphs 401 and 403 shown in FIG. 4, an X-axis may correspond to membrane potential values, and a Y-axis may correspond to spike values.

A boxcar function may refer to a function that outputs zero (0) across an entire real number line except for a single interval such as a constant A. The general boxcar function may have a window p of 0.5, which controls a membrane potential range through which a gradient may pass, as shown in the graph 401. In contrast, the extended boxcar function may have a window p of 1.0, which controls a membrane potential range through which a gradient may pass, as shown in the graph 403.

A computing device may use an SG method to solve an issue that may arise due to a non-differentiable nature of an activation function of a spiking neuron near a membrane potential threshold of the neuron, i.e., a “dead neuron problem” that may arise as weights of neurons are not updated. The computing device may replace the activation function of the spiking neuron, which is non-differentiable near the membrane potential threshold of the neuron, with a surrogate kernel, during backpropagation. The surrogate kernel may correspond to the extended boxcar function, and may also be referred to as a “boxcar kernel” in that the boxcar function is used as a kernel. The computing device may use, as the surrogate kernel, a boxcar function that is efficient for on-chip operation because an output value is 0 or 1. During the backpropagation of the activation function of the spiking neuron, gradients may flow more abundantly.

A membrane potential of a neuron may have temporal information due to the reflection of a LIF neuron model, and the temporal information may be reflected in the weight update rule as a value passed through the surrogate kernel.

The extended boxcar function shown in the graph 403 may be expressed as Equation 4 below.

$$[ Equation 4 ]$$

$$\frac{\partial S [ T ]}{\partial U [ T ]} = {Θ}^{′} ( U [ t ] - {ϑ}_{th} ) \to {U}_{} = {σ}^{′} ( {U}^{l} [ T ] ) = Θ ( \vert U [ t ] - {ϑ}_{th} \vert < p )$$

In Equation 4, σ(·) denotes a boxcar kernel. [symbol] _{U} denotes a result of a membrane potential, i.e., a value obtained after the membrane potential passes through the boxcar kernel. p denotes a window that controls a membrane potential range through which a gradient may pass. U denotes a membrane potential, and ϑₜₕ denotes a membrane potential threshold. Θ denotes a Heaviside function.

The boxcar kernel may output values of 0 and 1, which are easy to implement in hardware, for values according to a specific membrane potential range (e.g., a gradient range (ϑₜₕ−p, ϑₜₕ+p)). The boxcar kernel may be implemented as a switch using a transistor.

In an example embodiment, a window value p may be an optimized hyperparameter. The computing device may set the window value p to “1” in the graph 403, which is wider than “0.5” in the graph 401, to propagate gradients to membrane potentials of more neurons in the last time step of the SNN.

The computing device may expand a hardware-friendly boxcar kernel range to 0 to 2, as shown in the graph 403, and extend and apply a spatial gradient, thereby firing values that are far away than the membrane potential threshold.

In summary, during backpropagation, the computing device may replace an activation function of spiking neurons with an extended boxcar function in which a window controlling a membrane potential range through which gradients may pass is extended. In this case, the spiking neurons may correspond to spiking neurons near the membrane potential threshold.

FIG. 5 is a diagram illustrating an operation of a spike counter of an SNN according to an example embodiment. In the forward propagation path of FIG. 5, S[T] serves as an indicator of whether an output spike is generated from a particular neuron (e.g., S[T]=1 representing the occurrence of an output spike), and A[T] indicates the accumulation of the output spikes generated by the specific neuron (e.g., A[T]=5 representing that the output spike has been generated five times from the specific neuron). In the backpropagation path of FIG. 5, S[T] serves as an indicator of whether a gradient is propagated to a specific neuron (e.g., S[T]=1 representing the gradient being propagated, and S[T]=0 representing the gradient not being propagated), and A[T] indicates a gradient value to be applied to the specific neuron. Referring to FIG. 5, diagram 501 shows forward propagation and backpropagation operations of spiking neurons in which a spike counter by accumulative neurons A(T) selectively operates (i.e., the spike counter does not always operate) according to one embodiment, and diagram 503 shows forward propagation and backpropagation operations of spiking neurons in which a spike counter by accumulative neurons A(T) always operates according to another embodiment.

As spikes of spiking neurons S^{L}[T] fire during forward propagation as shown in the diagram 501, membrane potential values of the accumulative neurons A(T) may be accumulated, and during backpropagation, a gradient (or loss) may be propagated to spiking neurons depending on whether an output spike occurs in a corresponding spiking neuron during the forward propagation. That is, the gradient may be propagated back to first, third, fifth, sixth, eighth, and tenth spiking neurons at which output spikes occur during the forward propagation.

In contrast, as shown in the diagram 503, unlike the membrane potential values of the accumulative neurons A(T) corresponding to the spiking neurons S^{L}[T] fired during the forward propagation are accumulated, during the backpropagation, the gradient may be propagated to all the spiking neurons regardless of whether an output spike occurs during the forward propagation. In this case, accumulative neurons may be directly involved in generating a loss.

In the SNN according to an example embodiment, a spike output from the last layer or the last time step may be an output spike of a corresponding neural network model. To extend a gradient in the last time step of the SNN, the computing device may ignore a spatial gradient between a spike counter (e.g., the spike counter 171 of FIG. 1) and an occurrence of an output spike of the SNN (e.g., the SNN 150) but always fix the spatial gradient to “1,” as shown in the diagram 503.

The computing device may propagate the gradient to all the spiking neurons regardless of whether the spiking neurons S^{L}[T] fire during forward propagation of loss values, and may thereby apply an extended spatial gradient between the accumulative neurons A(T) and the occurrence of the output spike of the SNN and may successfully transmit a loss for all classes in the last time step of the SNN.

When potentials of accumulative neurons are filled by spikes of spiking neurons, the computing device may select an accumulative neuron having the highest potential value. The computing device may calculate an MSE loss between the potential value of the selected accumulative neuron and a ground truth or an MSE loss between the potential value of the selected accumulative neuron and a label from one-hot encoding and may propagate backward the calculated MSE loss.

The output spike generated in the last layer during the backpropagation of loss may contribute to the calculation of a spatial gradient that connects the accumulative neurons A(T). However, to ensure richer and more direct gradients, the computing device may ignore the spatial gradient as shown in the diagram 503 of FIG. 5 and aways fix the spatial gradient to “1” for all neurons, as expressed in Equation 5 below.

$$\frac{\partial A [ T ]}{\partial {S}^{L} [ T ]} \to 1 \qquad [ Equation 5 ]$$

In Equation 5, A[T] denotes an accumulative neuron A in a time step T, and S^{L}[T] denotes a spiking neuron S^{L} in the time step T.

In summary, the computing device may backpropagate a loss value of the last layer of the SNN to all the spiking neurons, regardless of whether the spiking neurons fire during the forward propagation of the loss value.

FIG. 6 is a diagram illustrating an always-on pooling operation according to an example embodiment. Referring to FIG. 6, diagram 600 shows max pooling 610, one pooling 620, and always-on pooling 630, which are used during forward propagation and backpropagation of an SNN.

As shown in the FIG. 6, the max pooling 610, the one pooling 620, and the always-on pooling 630 may all produce the same result in a forward propagation operation, while they may produce different results in a backpropagation operation.

When using the max pooling 610, the computing device may extract a maximum value within an area overlapping a kernel during forward propagation of a loss value, and, during backpropagation of the loss value, the computing device may propagate gradients only for elements 611, 612, 613, and 614 from which a feature (e.g., the maximum value) is selected during the forward propagation.

When using the one pooling 620, the computing device may also extract the maximum value within the area overlapping the kernel during the forward propagation of the loss value, in a similar way as in the max pooling 610. However, during the backpropagation of the loss value, the computing device may propagate gradients for six elements 621, 622, 623, 624, 625, and 626 having spike values during the forward propagation.

When using the always-on pooling 630, the computing device may extract the maximum value within the area overlapping the kernel, in a similar way as in the max pooling 610, during the forward propagation of the loss value. In contrast, during the backpropagation of the loss value, the computing device may extend and apply gradients regardless of whether a spike occurs. Therefore, during the backpropagation of the loss value, the gradients may be propagated to all 16 elements.

For example, a time at which the gradients are propagated may be different for each time step. However, when using the always-on pooling 630, the computing device may propagate the gradients to all the elements of the kernel at the same time, thereby providing all the elements with the same chance to apply the gradients. Using the always-on pooling 630 may increase an update probability.

FIG. 7 is a diagram illustrating an operation of an eligible potential generation circuit according to an example embodiment. FIG. 7 shows a forward propagation operation 701 and a backpropagation operation 703 by a SOLOet algorithm in which an eligible trace (or “et”) by an eligible spike (or eligible potential) is further considered in addition to whether a spike occurs.

In the BPTT method described above, gradients of spikes in time steps may be represented as eligible potentials in the form of leaky integration LI. In the BPTT method, all spatial-temporal gradients may be substantially represented in the LI form of specific spikes. This may be understood that when a spike is output temporally and a gradient corresponding to the spike exists, the gradient may be represented in the LI form of the corresponding spike. In this case, converting a temporal gradient into a spatial gradient may be referred to as an “eligible strategy” or “eligible trace.”

In an example embodiment, using an eligible potential generation circuit that extends this representation and replaces gradients of spikes in a final time step of an SNN with the calculation of eligible spikes over time steps may increase the number of eligible spike candidates during weight update. The eligible potential generation circuit may consider further an eligible spike \tilde{S}^{l}[T] in addition to whether a general spike occurs. The eligible spike may be calculated according to the concept of an eligible trace described above. In an example embodiment, more spatial gradients may be generated by replacing general spikes with eligible spikes.

The computing device may express an activity of a pre-synaptic neuron as computation of an eligible potential Ũ^{l}[T] and an eligible spike \tilde{S}^{l}[T].

First, the computing device may calculate an eligible potential Ũ^{l}[T] during a forward propagation operation in the SNN. The computing device may calculate the eligible spike Ũ^{l}[T] by applying a clamp function having a value of 0 or 1 to the eligible potential Ũ^{l}[T] and performing binarization. When the eligible potential Ũ^{l}[T] exceeds a threshold \tilde{ϑ}ₜₕ of the eligible potential Ù^{l}[T], an output spike signal may be generated. In this case, a gradient of the output spike signal may be represented as “grad ∈{0, 1}” by the binarization, and the size of the eligible potential Ũ^{l}[T][T] may be limited by the binarization.

The eligible spike \tilde{S}^{l}[T] calculated through the foregoing process may replace a spike, which is a computational element of weight update. The computing device may extend the eligible spike \tilde{S}^{l}[T] that replaces the spike to a spatial gradient to which temporal information is added for each layer, thereby increasing the number of eligible spike candidates updated in the last time step.

The eligible trace may reflect temporal data for an input spike and be reflected in a weight update rule. For the eligible trace, binary spikes may be used.

An operation of the eligible potential generation circuit that replaces gradients of spikes in the final time step T of the SNN with the computation of the eligible potential Ũ^{l}[T] and the eligible spike \tilde{S}^{l}[T] through time steps may be expressed as Equation 6 below.

$$\{ \begin{matrix}{\tilde{U}}^{l} [ T ] = k ( {α}^{l} {\tilde{U}}^{l} [ T - 1 ] + {aS}^{l - 1} [ T ] ) \\ {\tilde{S}}^{l} [ T ] = Θ ( {\tilde{U}}^{l} [ T ] - {\tilde{ϑ}}_{th} )\end{matrix} \qquad [ Equation 6 ]$$

In Equation 6, Ũ^{l}[T] may denote an eligible potential of a layer l. k(·) may denote a clamp function. α^{l}=exp(−1/τₛₚₖ^{l}) may denote a potential decaying constant of the layer l. τₛₚₖ^{l} may denote a time constant of an eligible spike. The time constant τₛₚₖ^{l} of the eligible spike may be a learnable parameter and may be shared by the same 126 layers of the SNN. In addition, a may denote a scaling constant.

In addition, S^{l-1} may denote an occurrence of an output spike of a neuron j in a layer l−1. \tilde{S}^{l}[T] may denote an eligible spike of the layer l. Θ(·) may denote a Heaviside function. \tilde{ϑ}ₜₕ may denote a threshold of the eligible spike. The threshold \tilde{ϑ}ₜₕ of the eligible spike may be different from a threshold ϑₜₕ of an action potential (or membrane potential) of the neurons described above.

In Equation 6, α^{l}Ũ^{l}[T−1] may correspond to a membrane potential of a spike of a previous time step. The eligible potential Ũ^{l}[T] may be calculated during forward propagation of a loss. α^{l}Ũ^{l}[T−1] may be remembered by the RC circuit. In addition, aS^{l-1}[T] may correspond to a scaled spike of a current time step.

For example, during forward propagation shown in the diagram 701, when an output spike S^{l-1}[1] is output from a pre-synaptic neuron in a previous layer l−1, a weight sum of the output spike S^{l-1}[1] and a weight W^{l} corresponding to the layer l may be transmitted to a membrane potential U^{l}[1]. In this case, a value transmitted to the membrane potential U^{l}[1] may output a spike to a post-synaptic neuron of the layer l through comparison with the threshold. For example, when the value transmitted to the membrane potential U^{l}[1] is greater than the threshold Uₜₕ of an action potential (or membrane potential), the spike may be output to the post-synaptic neuron of the layer l. As the spike is output from the post-synaptic neuron of the layer l, a membrane potential U^{l}[2] may be reset to “0.”

In this case, the value of the output spike S^{l-1}[1] transmitted to the membrane potential U^{l}[1] may be equally transmitted to a separate memory present below on the right side of the membrane potential U^{l}[1] to be used to generate a eligible spike \tilde{S}^{l}[1]. The computing device may scale and binarize the value of the output spike S^{l-1}[1] transmitted to the memory to generate the eligible spike \tilde{S}^{l}[1].

The foregoing process may be performed repeatedly from time step 1 to time step T. In this case, leakage may occur in a membrane potential U^{l} over time.

The computing device may store eligible spike values \tilde{S}^{l} as an eligible potential value (e.g., real value) in the memory for each time step and may use it in replacement of a spike corresponding to a corresponding time step. In this case, the eligible potential value and the membrane potential value may be different.

During the backpropagation of the loss value, the computing device may compare the eligible potential value stored in the memory to a threshold value spkₜₕ of an eligible spike. This comparison may be performed by a threshold comparator 930, which will be described below. When the eligible potential value is greater than or equal to the threshold value spkₜₕ of the eligible spike, the computing device may generate the eligible spike. When the eligible potential value is less than the threshold value spkₜₕ of the eligible spike, the computing device may accumulate the eligible potential value. The computing device may then use the eligible spike to update weights for the SNN. The threshold value spkₜₕ of the eligible spike may be, for example, 0.5, but is not necessarily limited thereto.

The computing device may change an eligible potential to an eligible spike through the process described above, and use the eligible spike for training the SNN, i.e., backpropagation of a loss for weight update.

In this case, a threshold \tilde{ϑ}ₜₕ of the eligible spike, a scaling constant a, a time constant τₛₚₖ^{l} of the eligible spike may correspond to learnable parameters. The learnable parameters may have better results by using pre-learned initial values, for example, ones shown in Table 1 below.

TABLE 1

| param | Initial Value | param | Initial Value |
|---|---|---|---|
| C | 128 | τ_{acc, init}^{A} | 2.0 |
| τ_{mem, init}^{l} | 2.0 | τ_{spk, init}^{l} | 0.5 |
| ϑₜₕ | 0.5 | ϑ̅ₜₕ | −0.35 |
| p | 1.0 | α | −0.8 |

Equation 7 below may be used to activate gradient propagation toward the time constant τₛₚₖ^{l} of the eligible spike, which is one of the parameters.

$$\{ \begin{matrix}\frac{\partial \text{?} [ T ]}{\partial {\tilde{S}}^{l} [ T ]} = \frac{\partial {U}^{l} [ T ]}{\partial \tilde{s} [ T ]} \frac{\partial \tilde{s} [ T ]}{\partial {\tilde{S}}^{l} [ T ]} = {W}^{l} \\ \frac{\partial {\tilde{S}}^{l} [ T ]}{\partial {\tilde{U}}^{l} [ T ]} = {Θ}^{′} ( {\tilde{U}}^{l} [ t ] - {\tilde{ϑ}}_{th} ) \to {\tilde{U}}_{l}^{} = Θ ( \tilde{U} [ t ] > \tilde{p} )\end{matrix} \qquad [ Equation 7 ]$$

$$\text{?} \text{indicates text missing or illegible when filed}$$

In Equation 7, \tilde{S}(·) may denote a switch function. [symbol] _{Ũ}^{l} may correspond to a result of applying a Heaviside kernel to an eligible potential. \tilde{P} may denote a window that controls a potential range through which a gradient may pass. W^{l} may denote a weight of a layer l.

An eligible spike \tilde{S}^{l}[T] that serves as a surrogate gradient of a spike for weight update may then be derived as expressed by Equation 8 below.

The eligible potential generation circuit may finally use a value obtained from Equation 8 as a value obtained by differentiating a membrane potential generated in a gradient chain of a weight update rule by a weight.

$$\frac{\partial {U}^{l} [ T ]}{\partial {W}^{l}} = {S}_{l - 1}^{} = {S}^{l - 1} [ T ] \to {\tilde{S}}_{l}^{} = {\tilde{S}}^{l} [ T ] \qquad [ Equation 8 ]$$

In Equation 8, [symbol] _{S}^{l-1} may denotes an occurrence of a spike in a layer l−1. [symbol] _{\tilde{S}}^{l} l may denote an eligible spike in the layer l.

The computing device may provide an eligible spike according to the concept and computation process of an eligible trace, and extend and apply a spatial gradient according to the spike occurrence through the eligible spike.

In addition, the computing device may denote potentials of accumulative neurons in a final layer using a firing rate that is given as A[T]/T and calculate an MSE loss. In this case, A[T] may denote an accumulative neuron A in a time step T.

A loss function of SOLO, L_{SOLO}, may be expressed as Equation 9 below.

$${L}_{SOLO} = {L}_{MSE} ( A [ T ] / T , \hat{y} ) \qquad [ Equation 9 ]$$

In Equation 9, ŷ may denote a target label.

According to the chain rule, slopes of Wᵢⱼ^{l} and τₘₑₘ^{l}, which are the learnable parameters, may be expressed as Equation 10 below.

$$\{ \begin{matrix}\frac{\partial {L}_{SOLO}}{\partial {W}^{l}} = {δ}^{l} [ T ] \frac{\partial {S}^{l} [ T ]}{\partial {U}^{l} [ T ]} \frac{\partial {U}^{l} [ T ]}{\partial {W}^{l}} = {δ}^{l} [ T ] {U}_{l}^{} {S}_{l - 1}^{} \\ \frac{\partial {L}_{SOLO}}{\partial {τ}_{mem}^{l}} = {δ}^{l} [ T ] \frac{\partial {S}^{l} [ T ]}{\partial {U}^{l} [ T ]} \frac{\partial {U}^{l} [ T ]}{\partial {τ}_{mem}^{l}} = {δ}^{l} [ T ] {U}_{l}^{} \frac{\partial {U}^{l} [ T ]}{\partial {τ}_{mem}^{l}}\end{matrix} \qquad [ Equation 10 ]$$

In Equation 10, δ^{l}[T] may denote a surrogate kernel and may be expressed as Equation 11 below.

$$[ Equation 11 ]$$

$${δ}^{l} [ T ] = \frac{\partial {L}_{SOLO}}{\partial {S}^{l} [ T ]} = \{ \begin{matrix}A [ T ] / T - \hat{y} & if l = L \\ {δ}^{l + 1} [ T ] \frac{\partial {S}^{l + 1} [ T ]}{\partial {U}^{l + 1} [ T ]} \frac{\partial {U}^{l + 1} [ T ]}{\partial {S}^{l} [ T ]} = {δ}^{l + 1} [ T ] {U}_{l}^{} {W}^{l} & if l < L\end{matrix}$$

In Equation 11, L may denote a total number of layers of the SNN.

In an example embodiment, for training the SNN, a first SOLO algorithm to which surrogate strategies 1 to 3, i.e., Surro1 to Surro3, are applied and a second online learning algorithm (e.g., SOLOet) to which the eligible potential generation circuit of surrogate strategy 4, i.e., Surro4, is applied may all be considered.

In the first SOLO algorithm, no gradient may be generated in remaining time steps except the last time step, but a gradient may be generated only in the last time step. In addition, because the first SOLO algorithm ignores a temporal loss and a spatial-temporal loss, it may not generate gradients for a membrane potential and a spike. In addition, in the second surrogate online learning algorithm, SOLOet, a spike trace and the eligible potential generation circuit may be added to each of all layers of the SNN.

According to the chain rule, the slopes of the learnable parameters may be derived as expressed in Equation 12 below.

$$\{ \begin{matrix}\frac{\partial {L}_{{SOL}_{et}}}{\partial {W}^{l}} = {δ}^{l} [ T ] \frac{\partial {S}^{l} [ T ]}{\partial {U}^{l} [ T ]} \frac{\partial {U}^{l} [ T ]}{\partial {W}^{l}} = {δ}^{l} [ T ] {U}_{l}^{} \text{?} \\ \begin{matrix}\frac{\partial {L}_{{SOL}_{et}}}{\partial {τ}_{spk}^{l}} = {δ}^{l} [ T ] \frac{\partial {S}^{l} [ T ]}{\partial {U}^{l} [ T ]} \frac{\partial {U}^{l} [ T ]}{\partial \text{?} [ T ]} \frac{\partial \text{?} [ T ]}{\partial \text{?} [ T ]} \frac{\partial {\tilde{U}}^{l} [ T ]}{\partial {τ}_{spk}^{l}} = \\ {δ}^{l} [ T ] {U}_{l}^{} {W}_{ij}^{l} \text{?} \frac{\partial \text{?} [ T ]}{\partial {τ}_{spk}^{l}}\end{matrix}\end{matrix} \qquad [ Equation 12 ]$$

$$\text{?} \text{indicates text missing or illegible when filed}$$

Learning surrogate gradients may be construed as a learning rule of three elements from surrogate strategy 1 Surro1 to surrogate strategy 3 Surro3 described above. A general weight from a layer l to a layer l−1 and a gradient of the first SOLO algorithm for a connection between two neurons (e.g., neurons i and j) may be expressed as Equation 13 below.

$$[ Equation 13 ]$$

$$\frac{\partial {L}_{{SOL}_{et}}}{\partial {W}_{ij}^{l}} = \frac{\partial {L}_{{SOL}_{et}}}{\partial {S}_{i}^{l} [ T ]} \frac{\partial {S}_{i}^{l} [ T ]}{\partial {U}_{i}^{l} [ T ]} \frac{\partial {U}_{i}^{l} [ T ]}{\partial {W}_{ij}^{l}} = \frac{\partial {L}_{{SOL}_{et}}}{\partial {S}_{i}^{l} [ T ]} {Θ}^{′} ( {U}_{i}^{l} [ t ] - {ϑ}_{th} ) \text{?} [ T ] \to {δ}_{i}^{l} [ T ] \text{?}$$

$$\text{?} \text{indicates text missing or illegible when filed}$$

In Equation 13, δᵢ^{l} may denote a global modulator. [symbol] _{U}_{ᵢ}^{l} may denote a surrogate gradient of a membrane potential of a post-synaptic neuron, which indicates an activity of the post-synaptic neuron. [symbol] _{\tilde{S}}_{ᵢ}^{l} may denote an activity of a traced pre-synaptic neuron.

The global modulator δᵢ^{l}, the surrogate gradient [symbol] _{U}_{ᵢ}^{l} of the membrane potential of the postsynaptic neuron, and the activity [symbol] _{\tilde{S}}_{ᵢ}^{l} of the traced pre-synaptic neuron may be of a type of the three-element learning rule. Weights may be partially updated with a global signal that uses a current-based LIF neuron model to represent the activity [symbol] _{\tilde{S}}_{ᵢ}^{l} and eligibility of the pre-synaptic neuron. However, it may not be easy to embed the current-based LIF neuron model in hardware.

Accordingly, in an example embodiment, the activity of the pre-synaptic neuron may be represented in the form of binarization calculated by an LI method that is similar to the dynamics of neurons while using a simple LIF neuron model including the eligible potential generation circuit.

FIG. 8 is a diagram illustrating an eligible trace by an eligible potential generation circuit according to an example embodiment. Referring to FIG. 8, graph 800 shows a modified sigmoid function (e.g., modified_sigmoid) for a clamp function for an eligible potential of an eligible potential generation circuit according to an example embodiment.

In the gradient chain of the BPTT method, a spike trace \tilde{S}^{l}[t] of a layer l may be represented in the form of a low-pass filter (LPF) as expressed by Equation 14 below.

$${\overline{S}}^{l} [ t ] = β {\overline{S}}^{l} [ t - 1 ] + {S}^{l} [ t ] \qquad [ Equation 14 ]$$

In Equation 14 above, β may denote a membrane potential decaying constant. \tilde{S}^{l} may denote a spike trace of a layer l. S^{l} may denote an occurrence of an output spike of a neuron in the layer l. t may denote a time step.

In an example embodiment, an eligible spike approximated from the concept of the spike trace expressed as Equation 14 may be used. However, because the spike trace may have a value greater than 0, the spike trace may be converted to a binary representation using the clamp function and a threshold value as expressed in Equation 15 below.

$$modified\_sigmoid ( x ) = \frac{1}{1 + {e}^{( - ( x - 0.5 ) * 8 )}} \qquad [ Equation 15 ]$$

The computing device may allow a value of the clamp function represented by the modified sigmoid function, modified_sigmoid, to be limited to a range of 0 and 1 centered at (0.5, 0.5). Limiting the value of the clamp function to be within the range of 0 and 1 may ensure that an eligible potential remains within a desired range. In addition, a threshold value (e.g., 0.5) may be applied to convert the eligible potential to a binary representation that is referred to as an eligible spike. In this case, the computing device may consider a gradient flowing to a parameter τₛₚₖ^{l}.

FIG. 9 is a diagram illustrating an example of a CBA circuit in which an eligible potential generation circuit is implemented according to an example embodiment. FIG. 9 shows an eligible potential generation circuit 130 implemented as a circuit on a CBA of an SNN 150 according to an example embodiment.

The eligible potential generation circuit 130 may represent an activity of a pre-synaptic neuron of the SNN 150 and apply an eligible trace to update weights of the SNN 150. The eligible potential generation circuit 130 may be applied by being replaced with a gradient computation element of the chain rule on the CBA 900 in the form of a binary local temporal memory.

The eligible potential generation circuit 130 may include at least one of an eligible potential circuit 910, a threshold comparator 930, or a flag generator 950.

The eligible potential circuit 910 may receive a pulse from the pulse generator 110 and may calculate a time-dependent eligible potential value corresponding to the received pulse in the form of LI by an RC circuit.

The threshold comparator 930 may compare the eligible potential value of the eligible potential circuit 910 to a threshold spkₜₕ of an eligible spike. The threshold comparator 930 may include, for example, an operational amplifier (OP-AMP) circuit or a bi-stable circuit with a series of NOT gates, but is not necessarily limited thereto.

The flag generator 950 may store a flag value corresponding to the eligible spike based on a result of the threshold comparison described above. In this case, the flag value may be applied as a pulse that selects a synaptic cell 151 from rows of the CBA 900 constituting the SNN 150.

During forward propagation in the eligible potential generation circuit 130, an input of the CBA 900 of the SNN 150 and an input of the eligible potential generation circuit 130 may be calculated (or computed) in parallel and may be distinguished from each other. In this case, the pulse generator 110 may generate a pulse corresponding to a spike as an input to a row of the CBA 900 of the SNN 150 and directly apply the pulse. At the same time, each eligible potential generation circuit 130 may also receive a pulse corresponding to a spike from the pulse generator 110.

During the forward propagation, each eligible potential generation circuit 130 may compute an eligible potential. The eligible potential generation circuit 130 may include, for example, the RC circuit including a resistor R and a capacitor C. In the RC circuit, the resistance R may be implemented as a variable resistance and may be learned according to a gradient of the chain rule.

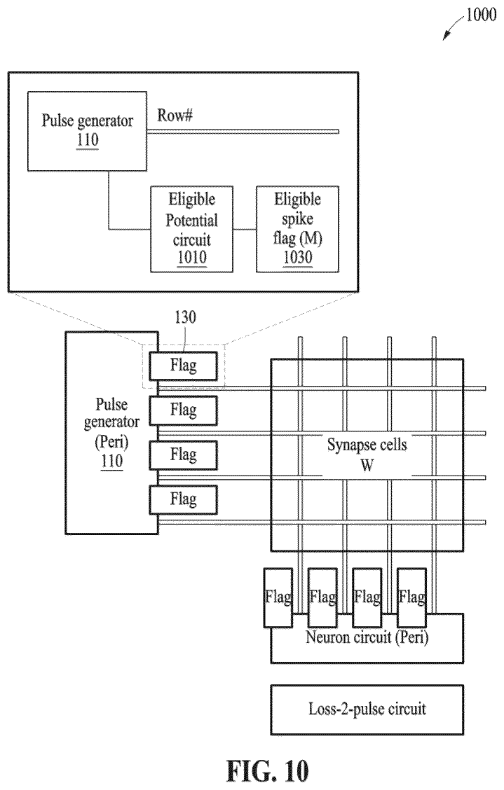

The eligible potential generation circuit 130 may calculate a potential value over time in the form of LI through the RC circuit. For example, an eligible potential circuit 1010, which will be described below with reference to FIG. 10, may be implemented as the RC circuit.

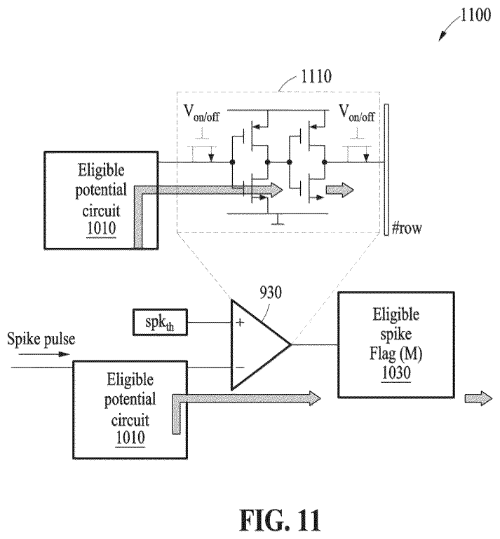

The RC circuit may receive a pulse corresponding to a spike generated by the pulse generator 110. The pulse may be applied to the RC circuit as an eligible potential value. The threshold comparator 930 may compare the eligible potential value to a threshold spkₜₕ of an eligible spike. Based on a result of the comparison from the threshold comparator 930, a value of 0 or 1 corresponding to the eligible spike may be output through the flag generator 950 implemented as a transistor. The value of 0 or 1 output in this way may be stored as a value of an eligible spike flag 1030, which will be described below with reference to FIG. 10. The threshold comparator 930 may be configured as, for example, an OP-AMP, but is not necessarily limited thereto. The threshold comparator 930 may include two NOT gates as shown in FIG. 11.

In addition, when using a leakage current of one transistor-one capacitor (1T 1C) with a capacitor attached to one of a source terminal and a drain terminal of the flag generator 950, the eligible potential generation circuit 130 may be implemented along with a memory with a potential degradable characteristic, i.e., a memory with low retention, such as, for example, a flash memory. During backpropagation, the eligible potential generation circuit 130 may calculate an eligible spike by discretizing an eligible potential. The eligible potential generation circuit 130 may use a method by which power is applied only at a specific time, such as, for example, during backpropagation. After calculating the eligible spike, the eligible potential generation circuit 130 may apply Von/off in the form of a binary value of 0 or 1 to the flag generator 950 implemented with a transistor corresponding to a switch as shown in to reflect the binary value of 0 or 1 in the CBA 900 of the SNN 150. In this case, the binary value 0 or 1 may be applied as a pulse that selects a synaptic cell in a row of the CBA 900 of the SNN 150. That is, the row may be selected from the CBA 900 of the SNN 150 by the value of 0 or 1 output from the flag generator 950. In this case, the flag generator 950 may adjust a time for applying the eligible spike.

For the eligible potential generation circuit 130, using a switch function denoted as \tilde{S}(·), for example, may not generate a spike on a backward path but use an eligible spike.

In this case, the switch function \tilde{S}(·) may output only one variable during a forward path. When two variables are received, the switch function may use a left variable during forward propagation, but may block a gradient flowing to the left variable to allow the gradient to flow to a right variable during backpropagation. Therefore, when using an eligible spike, a spike that has already occurred may be used during forward propagation, but when calculating a gradient, an eligible spike may be used instead of a spike occurrence.

The eligible potential generation circuit 130 may maintain a gradient chain for any two variables (F,\tilde{F}) during a backward pass to ensure that a gradient is propagated to the two variables. In this case, a slope of the two variables (F,\tilde{F}) may be 1 as expressed in Equation 16 below.

$$\tilde{s} ( F , \tilde{F} ) = F \qquad [ Equation 16 ]$$

$$\frac{\partial \tilde{s} ( F , \tilde{F} )}{\partial F} = \frac{\partial \tilde{s} ( F , \tilde{F} )}{\partial F} \to 1$$

Therefore, in an example embodiment, a switch function with an eligible spike may be used as expressed in Equation 17 below.

$$\tilde{s} ( {S}^{l} [ T ] , {\tilde{S}}^{l} [ T ] ) = {S}^{l} [ T ] \qquad [ Equation 17 ]$$

$$\frac{\partial \tilde{s} ( {S}^{l} [ T ] , {\tilde{S}}^{l} [ T ] )}{\partial {S}^{l} [ T ]} = \frac{\partial \tilde{s} ( {S}^{l} [ T ] , {\tilde{S}}^{l} [ T ] )}{\partial {\tilde{S}}^{l} [ T ]} \to 1$$

Equation 17 may correspond to a gradient chain that occurs in a process of replacing an eligible spike using the switch function. By taking a partial derivative of each of a spike occurrence and an eligible spike with respect to the switch function, the gradient chain may be generated for each of the spike occurrence and the eligible spike. The method of replacing an eligible spike using the switch function is provided herein as an example of various known replacement methods, and examples of which are not necessarily limited thereto.

In an example embodiment, the partial derivative value of each of the spike occurrence and the eligible spike with respect to the switch function may be set to “1” in the process such that a corresponding gradient value is ignored.

FIG. 10 is a block diagram illustrating an eligible potential generation circuit according to an example embodiment. FIG. 10 shows an eligible potential generation circuit 1000.

The eligible potential generation circuit 1000 may include an eligible potential circuit 1010 and an eligible spike flag 1030. The eligible spike flag 1030 may also be referred to as a “surrogate flag.”

The eligible potential circuit 1010 may receive a pulse corresponding to a spike generated by the pulse generator 110. The pulse may be applied as an eligible potential value to an RC circuit corresponding to the eligible potential circuit 1010. The threshold comparator 930 may compare the eligible potential value to a threshold spkₜₕ of an eligible spike. Based on a result of the comparison from the threshold comparator 930, the eligible spike flag 1030 of 0 or 1 corresponding to the eligible spike may be generated and/or stored. A flag shown on the right side of the pulse generator 110 in FIG. 10 may represent the eligible spike of 0 or 1.

A computing device may store the eligible spike flag 1030 in a last time step of an SNN.

FIG. 11 is a diagram illustrating an example of a threshold comparator for an eligible spike according to an example embodiment. Referring to FIG. 11, diagram 1100 shows an example of the threshold comparator 930 for an eligible spike of an eligible potential generation circuit according to an example embodiment.

A time-dependent potential calculated in the form of LI in the eligible potential circuit 1010 of the eligible potential generation circuit may be compared in the threshold comparator 930 and may then be stored as the eligible spike flag 1030 corresponding to a binary output value of 0 or 1. In this case, the threshold comparator 930 may be configured as a bi-stable circuit 1110 similar to a static random-access memory (SRAM).

In an example embodiment, a regenerative characteristic of the bi-stable circuit 1110 may be used to perform the threshold comparison. The bi-stable circuit 1110 may be, for example, a circuit with two NOT gates in a row, but is not necessarily limited thereto. The bi-stable circuit 1110 may directly reflect a leaky spike value output from the eligible potential circuit 1010 without using a binarization circuit.

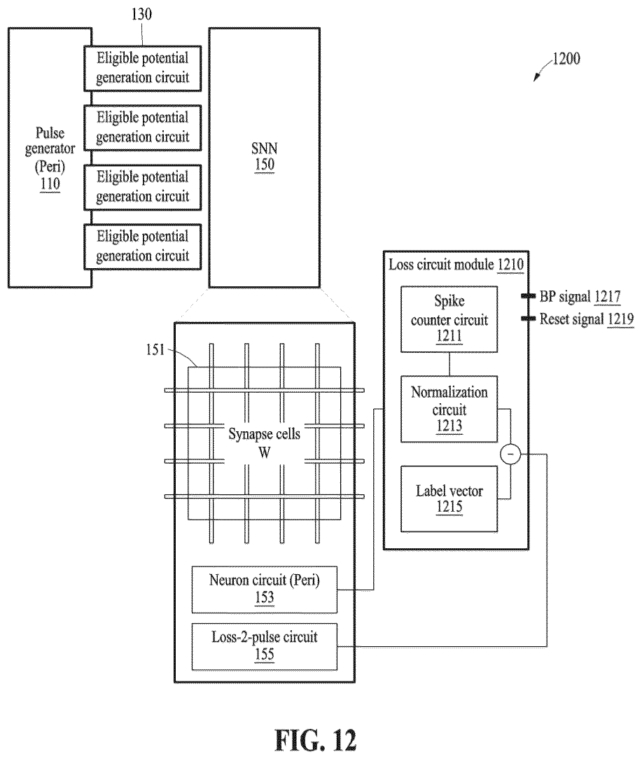

FIG. 12 is a diagram illustrating a structure and operations of a loss circuit module of an SNN according to an example embodiment. Referring to FIG. 12, a computing device 1200 may include a pulse generator 110, eligible potential generation circuits 130, an SNN 150, and a loss circuit module 1210.

The loss circuit module 1210 may include a spike counter circuit 1211, a normalization circuit 1213, and a label vector 1215. The loss circuit module 1210 may be based on a specific loss, such as, for example, a cross-entropy loss and/or MSE loss. The loss circuit module 1210 may transmit, to the normalization circuit 1213, a potential accumulated in the spike counter circuit 1211 for all time steps. The loss circuit module 1210 may represent, as a loss value, a difference between the potential value transmitted to the normalization circuit 1213 and a value stored in the label vector 1215. The loss value calculated in the loss circuit module 1210 may be transmitted back to a loss-2-pulse circuit 155 of the SNN 150. The loss-2-pulse circuit 155 may generate a pulse corresponding to the transmitted loss value and transmit the pulse to a neuron circuit 153. The neuron circuit 153 may apply a learning rate value to the loss value and reflect it in the weight update rule.

The loss circuit module 1210 may not operate for all the time steps but may operate in a specific time step by receiving a specific signal.

For the operations of the spike counter circuit 1211, reference may be made to the operations of the spike counter circuit 171 described above with reference to FIG. 1. In addition, for the operations of the normalization circuit 1213, reference may be made to the operations of the normalization circuit 173 described above with reference to FIG. 1.

In addition, for a BP signal 1217 and a reset signal 1219, reference may be made to what has been described above regarding the BP signal 177 and the reset signal 179 with reference to FIG. 1.

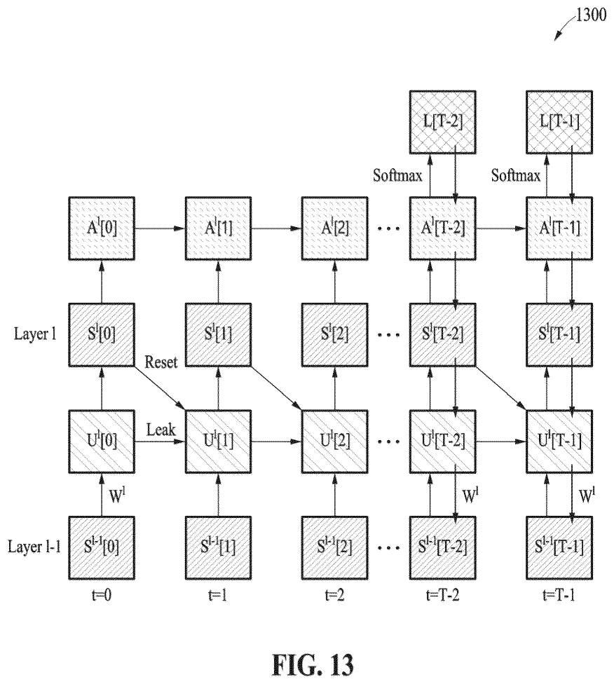

FIG. 13 is a diagram illustrating a method of performing backpropagation in a specific time step of a SOLO algorithm used to train an SNN according to an example embodiment. Referring to FIG. 13, roll-up diagram 1300 shows backpropagation performed in a specific time step according to an example embodiment.

A computing device may perform backpropagation on a spatial loss in a specific time step among time steps given for forward propagation. Potentials may be mainly filled in accumulative neurons, and backpropagation of spatial errors may be performed in successive time steps based on a last time step. In the roll-up diagram 1300, a time step in which the backpropagation described above is performed may be referred to as a “BP step.”

The computing device may receive a BP signal in the BP step but may not receive a reset signal every time. For example, the reset signal may operate after the BP signal operates in the last time step of given time steps for an image.

The backpropagation shown in FIG. 13 may be performed mainly on static data.

The computing device may update a weight W for one input data through several time steps. In this case, as a time step increases, a temporal gradient, a spatial gradient, and/or a spatial-temporal gradient may increase. When a gradient increases, the amount of the weight W update may increase, and a frequency of the weight W selected to be updated may also increase. When a weight is desirably selected and updated through an increase in the weight update by an increase in gradient, a learning effect may increase, and the accuracy may converge fast.

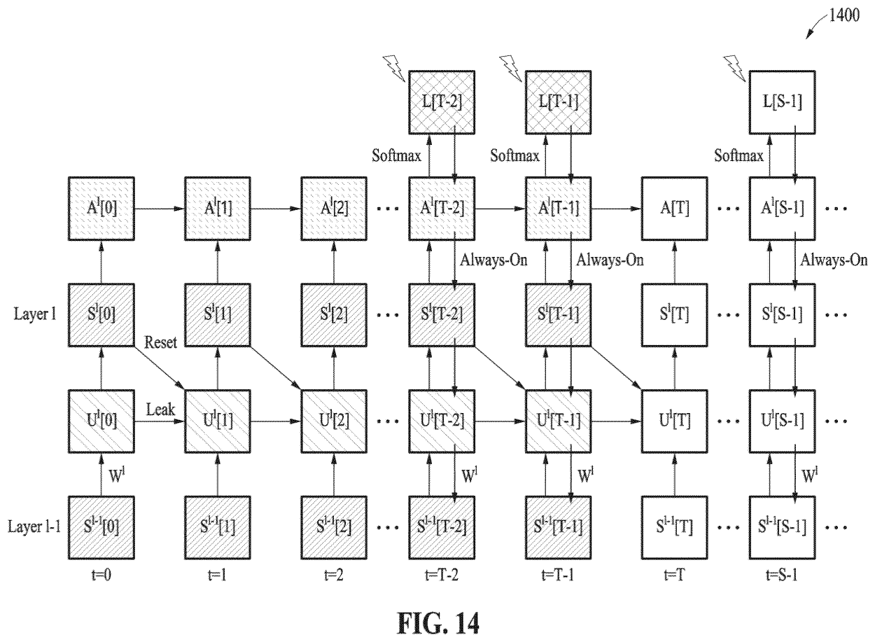

FIG. 14 is a diagram illustrating a method of performing backpropagation in a specific time step of a SOLO algorithm by receiving a signal from a specific module of an SNN according to an example embodiment. Referring to FIG. 14, roll-up diagram 1400 shows backpropagation performed for a spatial error in a time step selected from a specific module of an SNN according to an example embodiment.

A computing device may perform backpropagation of spatial errors in a given time step of forward propagation. In this case, a loss circuit module of the computing device may receive a signal from a specific module and perform backpropagation in a specific time step.

The computing device may not perform backpropagation for successive time steps of a BP step but may perform backpropagation by receiving a BP signal from a specific operation module that selects the BP step. In this case, the specific operation module may correspond to a module that processes metadata such as context data and feature data but is not necessarily limited thereto.

In the BP step, the computing device may receive a BP signal but may not receive a reset signal every time. For example, the reset signal may operate after the BP signal operates in a last time step of given time steps for one data. In this case, the reset signal may be periodically applied in a given time step to reset a potential of an accumulative neuron. The backpropagation shown in FIG. 14 may be applied mainly to temporal data.

The computing device may update a weight for one input data several times over time, and as described above, as the number of updates is repeated, the frequency of the selected weight may increase. This may allow the computing device to learn about temporal data, and when performing the weight update at a high frequency, reduce the convergence speed of accuracy.

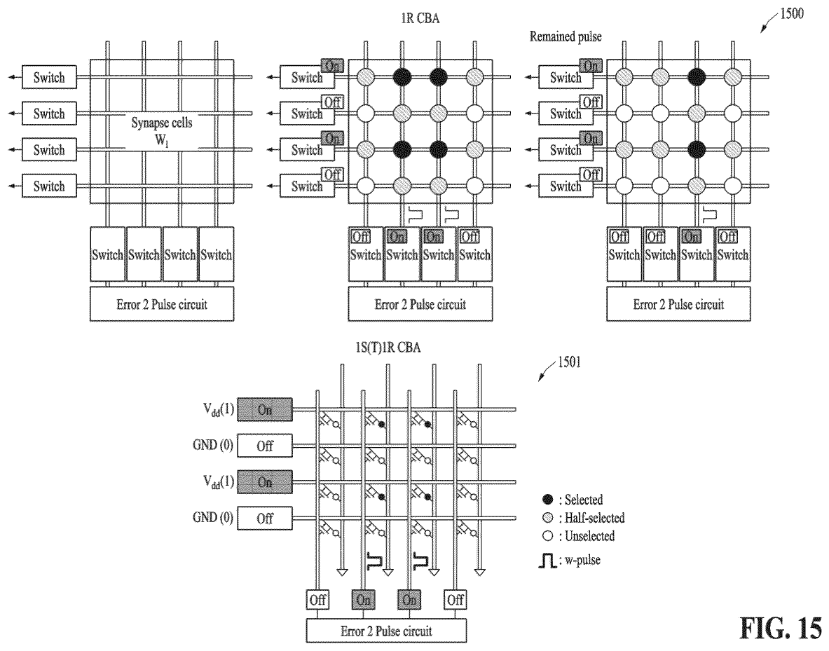

FIG. 15 is a diagram illustrating an example of a CBA system in which an SNN is implemented according to an example embodiment. Referring to FIG. 15, diagram 1500 shows a CBA without a selector S, and diagram 1501 shows a CBA with the selector S according to an example embodiment.

According to an example embodiment, weight update may be readily and intuitively implemented in a CBA application of a resistance-based non-volatile memory (NVM).

A computing device may ease a half-selected phenomenon by selecting a weight through a switch added to the CBA as shown in the diagram 1500 or by selecting a weight through on-off type Vdd and ground (GND). In this case, the half-selected phenomenon may correspond to a practical hardware issue occurring when a memory array is generated in the form of a CBA, which is referred to as computing in memory (CIP), and such a system performs deep neural network (DNN) computation and updates weights. To update the weights, a specific cell may need to be selected from the memory array. In this case, when a row and column of the memory array are selected to select the specific cell, only one side of the memory positioned in the corresponding row and column may be selected, which may correspond to the half-selected phenomenon. In this case, when only the one side of the memory is selected, the weights may be updated in an unintended way. The computing device may update the weights by transmitting a weight update pulse or a programming pulse for a selected weight.

An algorithm according to an example embodiment may prevent or reduce the half-selected phenomenon by selecting a weight through a switch added to the CBA or by selecting a weight through an on-off type Vdd and GND.

Alternatively, the computing device may resolve the half-selected phenomenon by binarizing an eligible potential to 0 or 1 through the selector as shown in the diagram 1501.

The update of a weight wᵢⱼ^{l} in the CBA using the SOLO algorithm according to an example embodiment may be expressed as Equation 18 below.

$$[ Equation 18 ]$$

$$\frac{\partial {L}_{SOLO}}{\partial {w}_{ij}^{l}} = {δ}_{i}^{l} [ T ] \frac{\partial {S}_{i}^{l - 1} [ T ]}{\partial {U}_{i}^{l} [ T ]} \frac{\partial {U}_{i}^{l} [ T ]}{\partial {w}_{ij}^{l}} = ( A [ T ] / T - \hat{y} ) {σ}^{′} ( {U}_{i}^{l} ) {S}_{j}^{l - 1} [ T ]$$

In Equation 18, (A[T]/T−ŷ) may correspond to a loss term of the SNN. σ′(Uᵢ^{l}) may correspond to a membrane potential value of a post-synaptic neuron that has passed through a surrogate kernel. σ′(Uᵢ^{l}) may have a value of 0 or 1. In addition, Sⱼ^{l-1} [T] may correspond to a spike value of a pre-synaptic neuron. Sⱼ^{l-1}[T] may also have a value of 0 or 1.

In an example embodiment, calculating information of the pre-synaptic neuron and the post-synaptic neuron to be 0 or 1 using the SOLO algorithm may facilitate the implementation in hardware.

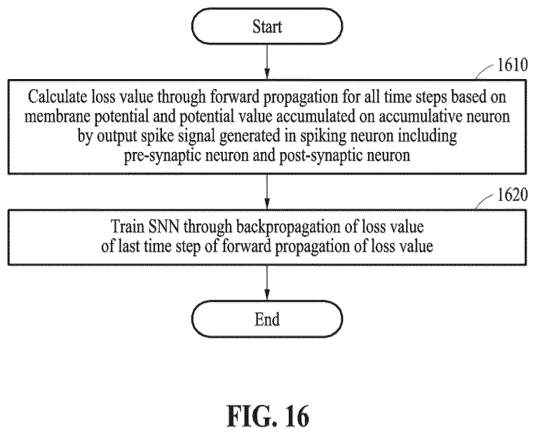

FIG. 16 is a flowchart illustrating a training method performed by a computing device to train an SNN according to an example embodiment. Referring to FIG. 16, an SNN of a computing device according to an example embodiment may include layers including pre-synaptic neurons, membrane potentials, post-synaptic neurons, and accumulative neurons. Each of the layers may train the SNN through operations 1610 and 1620 described below.

In operation 1610, the computing device may calculate a loss value through forward propagation for all time steps based on a membrane potential and a potential value accumulated in an accumulative neuron by an output spiking signal generated from a spiking neuron including a pre-synaptic neuron and a post-synaptic neuron.

In operation 1610, the computing device may perform the following operations for each of all the time steps. The computing device may receive an output spike signal output from a pre-synaptic neuron of a previous layer. The computing device may transmit, to a membrane potential, a potential value that is obtained by calculating a weighted sum of a potential value accumulated by the output spike signal and a weight corresponding to a current layer. The computing device may output a loss value corresponding to the current layer based on a difference between the potential value transmitted to the membrane potential and a membrane potential threshold value. The computing device may calculate an eligible spike value by scaling and binarizing the output spike signal with a clamp function. The computing device may store the eligible spike value in a memory as an eligible potential value for each time step.

In operation 1620, the computing device may train the SNN by backpropagating a loss value of a last time step of the forward propagation of the loss value. The computing device may compare the eligible potential value stored in the memory to a threshold value of an eligible spike. In this case, when the eligible potential value is greater than or equal to the threshold value of the eligible spike, the computing device may generate the eligible spike and update a weight for the SNN to train the SNN.

The examples described herein may be implemented using hardware components, software components and/or combinations thereof. A processing device may be implemented using one or more general-purpose or special purpose computers, such as, for example, a processor, a controller, an arithmetic logic unit (ALU), a digital signal processor, a microcomputer, a field programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For the purpose of simplicity, the description of a processing device is used as singular; however, one skilled in the art will be appreciated that a processing device may include multiple processing elements and multiple types of processing elements. For example, a processing device may include multiple processors or a processor and a controller. In addition, different processing configurations are possible, such as, parallel processors.

The software may include a computer program, a piece of code, an instruction, or some combination thereof, to independently or collectively instruct or configure the processing device to operate as desired. Software and/or data may be embodied permanently or temporarily in any type of machine, component, physical or virtual equipment, computer storage medium or device, or in a propagated signal wave capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described examples may be recorded in non-transitory computer-readable media including program instructions to implement various operations of the above-described examples. The media may also include, alone or in combination with the program instructions, data files, data structures, and the like. The program instructions recorded on the media may be specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as ROM, RAM, flash memory (e.g., USB flash drives, memory cards, memory sticks, etc.), and the like. Examples of program instructions include both machine code, such as produced by a compiler, and files containing higher-level code that may be executed by the computer using an interpreter.

The above-described hardware devices may be configured to act as one or more software modules in order to perform the operations of the above-described examples, or vice versa.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A computing device comprising:
a pulse generator configured to generate a pulse corresponding to an input spike signal;
a spiking neural network (SNN) comprising layers of spiking neurons configured to generate an output spike signal in response to the pulse being received from the pulse generator; and
a loss circuit module configured to calculate a loss value based on a potential value accumulated by the output spike signal and backpropagate the loss value to the SNN.

2. The computing device of claim 1, wherein the SNN is configured to:
calculate the loss value for all time steps of forward propagation,
wherein the loss circuit module is further configured to:
backpropagate the loss value of a last time step of the forward propagation.

3. The computing device of claim 1, wherein the SNN comprises at least one of:
a plurality of synaptic cells configured to store weight values in a crossbar array;
a neuron circuit that is based on a current-based leaky integrate-and-fire (LIF) neuron model in which an activity of a pre-synaptic neuron among the spiking neurons is reflected; or
a loss-2-pulse circuit configured to receive the loss value calculated by the loss circuit module, generate a pulse corresponding to the loss value, and transmit the pulse to the neuron circuit.

4. The computing device of claim 1, wherein the loss circuit module is further configured to:
normalize the accumulated potential value and calculate the loss value based on a difference between the normalized potential value and a label vector.

5. The computing device of claim 4, wherein the loss circuit module comprises:
a spike counter circuit configured to accumulate the potential value obtained from the output spike signal;
a normalization circuit configured to normalize the accumulated potential value; and
a loss circuit configured to calculate the loss value based on the difference between the normalized potential value and the label vector.

6. The computing device of claim 1, wherein the SNN is further configured to, during backpropagation, replace an activation function of the spiking neurons with an extended boxcar function in which a window configured to regulate a membrane potential range for passing gradients is extended.

7. The computing device of claim 1, wherein the SNN is further configured to backpropagate, to all the spiking neurons, the loss value of a last layer of the SNN, regardless of whether the spiking neurons fire during forward propagation of the loss value.

8. The computing device of claim 1, wherein the SNN is further configured to, during the backpropagation of the loss value, propagate the loss value to all elements of a kernel at a same time.

9. The computing device of claim 1, further comprising:
an eligible potential generation circuit configured to receive the pulse, calculate an eligible potential value corresponding to the pulse, and transmit the calculated eligible potential value as the output spike signal to the SNN.

10. The computing device of claim 9, wherein the eligible potential generation circuit is further configured to:
calculate the eligible potential value by applying a clamp function to a result of adding a membrane potential value of a spike of a previous time step and a scaled spike value of a current time step.

11. The computing device of claim 10, wherein the eligible potential generation circuit is further configured to:
calculate an eligible spike by applying a Heaviside function to a difference between the eligible potential value and a threshold value of the eligible spike.

12. The computing device of claim 9, wherein the SNN is further configured to compute a weighted sum of the output spike signal that is output from the eligible potential generation circuit using a weight stored in a synaptic cell of the SNN, and
store the weighted sum in a neuron circuit of the SNN.

13. The computing device of claim 9, wherein the eligible potential generation circuit comprises at least one of:
an eligible potential circuit configured to calculate the eligible potential value according to time corresponding to the pulse to be in a leaky-integration (LI) form by a resistor-capacitor circuit;
a threshold comparator configured to compare the eligible potential value to a threshold value of an eligible spike; or
a flag generator configured to store a flag value corresponding to the eligible spike based on a comparison between the eligible spike and the threshold value.

14. The computing device of claim 13, wherein the SNN comprises a crossbar array,
wherein the flag value is applied as a pulse that selects a synaptic cell from rows of the crossbar array.

15. The computing device of claim 13, wherein the threshold comparator comprises:
an operational amplifier circuit or a bi-stable circuit comprising a series of NOT gates.

16. The computing device of claim 1, wherein the loss circuit module is configured to:
in response to a backpropagation signal being input, calculate the loss value and backpropagate the loss value to the SNN; and
in response to a reset signal, reset the accumulated potential value stored in a spike counter circuit of the loss circuit module.

17. A training method of a computing device to train a spiking neural network (SNN),
wherein the SNN comprises:
a plurality of layers each comprising a pre-synaptic neuron, a membrane potential, a post-synaptic neuron, and an accumulative neuron, and
wherein the training method comprises:
calculating a loss value through forward propagation for all time steps based on the membrane potential and a potential value accumulated in the accumulative neuron in response to an output spike signal generated from a spiking neuron, the spiking neuron comprising the pre-synaptic neuron and the post-synaptic neuron; and
training the SNN by backpropagating a loss value of a last time step of the forward propagation of the loss value.

18. The training method of claim 17, wherein the calculating of the loss value through the forward propagation comprises:
for each of all the time steps,
receiving the output spike signal that is output from the pre-synaptic neuron of a previous layer;
transmitting, to the membrane potential, a value obtained by a weighted sum of the potential value accumulated by the output spike signal and a weight corresponding to a current layer;
outputting a loss value corresponding to the current layer based on a difference between the value transmitted to the membrane potential and a membrane potential threshold value;
calculating an eligible spike value by scaling the output spike signal based on a clamp function and performing binarization; and
storing, in a memory, the eligible spike value as an eligible potential value for each of the time steps.

19. The training method of claim 17, wherein the training of the SNN comprises:
comparing the eligible potential value stored in a memory to a threshold value of an eligible spike; and
in response to the eligible potential value being greater than or equal to the threshold value of the eligible spike, generating the eligible spike and updating a weight for the SNN to train the SNN.

20. A non-transitory computer-readable storage medium storing instructions that are executable by a processor to perform a training method for training a spiking neural network (SNN),
wherein the SNN comprises a plurality of layers each comprising a pre-synaptic neuron, a membrane potential, a post-synaptic neuron, and an accumulative neuron, and
wherein the training method comprises:
calculating a loss value through forward propagation for all time steps based on the membrane potential and a potential value accumulated in the accumulative neuron in response to an output spike signal generated from a spiking neuron, the spiking neuron comprising the pre-synaptic neuron and the post-synaptic neuron; and
training the SNN by backpropagating a loss value of a last time step of the forward propagation of the loss value.
